(19) United States
(12) Patent Application Publication
(10) Pub. No.: US 2015/0026260 A1
(43) Pub. Date: Jan. 22, 2015

(54) Community Knowledge Management System

(71) Applicant: Donald Worthley, Nixa, MO (US)

(72) Inventor: Donald Worthley, Nixa, MO (US)

(21) Appl. No.: 14/275,546

(22) Filed: May 12, 2014

Related U.S. Application Data
(63) Continuation of application No. 12/661,008, filed on Mar. 9, 2010, now abandoned.
(60) Provisional application No. 61/209,567, filed on Mar. 9, 2009.

(51) Int. Cl. H04L 29/08

(52) U.S. Cl. CPC H04L 67/306; H04L 67/02
USPC 709/204

(57) ABSTRACT

A web-based Community Knowledge System (CKS), including member community features, content management system features and custom features for specific lines of business or industries.

### BACKGROUND OF THE INVENTION

1. Field of the Invention

The present invention relates to the fields of knowledge management and content management systems. Another related field would be the field of enterprise wikis.

2. Discussion of the Related Art

A summary of some of the limitations of related art includes.
Organizations excel based on their ability to share knowledge in their communities.
Social-networking tools, while powerful, create disconnected data islands
The tools don't scale well. As the knowledge pool increases, usability decreases.
Social networking has been limited to blogs, wikis, forums and bookmarks.
Community knowledge is often missing its context.
Semantic web solutions to this problem are too complex.
Public social media is often too varied in focus
Knowledge is changing too rapidly for older systems to keep up

At the heart of any organization is the desire to pool resources from a variety of sources such as employees, contractors, vendors or members and make those resources available to those in or associated with the organization that would benefit from this shared body of knowledge. At the center of this goal is the need for tools and venues to facilitate communication among all those who would participate in the community of the organization. For some organizations, such as associations and non-profit organizations, the majority of community knowledge sharing occurs through conferences and printed publications.

Increasingly, organizations are using the web to facilitate this kind of community; and, while there are a number of exciting tools and technologies available such as blogs, wikis and forums, these tools are often implemented in an uncoordinated fashion. There has been an incredible amount of interest in the new Web 2.0 suite of social networking and social media web applications and many products have been developed around the ability to share information in open and easily accessible formats; however, these tools often lead to small data islands that require integration resources to pull the data together into a format that is meaningful for the average information worker.

Although some organizations have been quick to make use of the new social media tools, they often quickly find that the amount of data entered into the community repositories grows exponentially and quickly becomes difficult to manage. This leads to a situation where usability decreases in spite of the fact that the amount of useful information in the system is increasing. It's just too hard to find information when the data store gets too large.

Furthermore, there are many types of data that are routinely shared by members of an organization that have not been captured by social networking tools. Some of this data is currently shared in a community using expensive third party software, such as job boards or community survey solutions, but in many cases the software used to manage jobs or surveys does not lend itself well to community ownership of the data.

Finally, while the use of tagging systems which are so prevalent in Web 2.0 software have helped to provide a way to quickly and easily classify community knowledge, these systems often lack the precision needed when sharing information within an organization. The use of =different terms by different members to tag content may leave valuable information hidden. The use of these systems also does not help to propagate a common language for use in describing a specific domain of knowledge.

As a community's body of knowledge grows, it becomes like a book without a table of contents. There's an index which takes the form of the enterprise search strategies available today, but there's no meaningful context for the data: There's no way to say that this article relates to this particular aspect of this subject as defined in the community table of contents.

Moreover, the current efforts to solve the problem related to the problem of missing context are too complex and too burdensome for the enterprise to be of any value. This is particularly true of the efforts related to the semantic web and to the approach in general of mapping enterprise data to formal tools for classification such as ontologies.

While we believe that the need for context related to enterprise data is high, we believe the overhead of the current approaches recommended by proponents of the semantic web may be too high for the enterprise. In The Semantic Web, Syllogism and Worldview, Clay Shirky argues this point convincingly. Any solution to the issue of the missing context for enterprise data that will find widespread adoption must be simple to understand, easy to use and it must dramatically increase the discoverability of data. While the semantic web and other similar approaches do increase the discoverability of enterprise data, the cost of doing so is often jokingly estimated at being higher than the cost of boiling the ocean.

One issue that everyone who uses social media sites today faces is the fact that these sites are often used by people from a variety of backgrounds. A great example is the book reviewing system at Amazon.com. It's not uncommon for shills to review books and for people with little or no experience in your industry or your area of interest to write reviews for the books. In the end, the signal to noise ratio is too high to trust the information.

Another issue that many organizations face today is the rapid pace of change inside of business domains. It is said that the knowledge base in a typical enterprise doubles every two years. In addition to this constant expansion in the base of knowledge within an organization, there is a high degree of change that occurs within the existing knowledge base. In some industries, such as the IT industry, a vast majority of a working knowledge base may change every 18 months. As a result of this delta in knowledge, current approaches to managing community data in an R. enterprise are often too rigid, or are associated too closely with organizational hierarchies or politics to allow an organization's members to find actionable intelligence when it is needed. Adding some type of solution built on top of the semantic web may only exacerbate this problem, since each entity in a given domain may require extensive documentation regarding its properties as well as the relationships and the meaning of those relationships between said entity and other entities in the system.

### SUMMARY OF THE INVENTION

In light of these issues, IT Crossing plans to design and build Member Crossing, a web-based Community Knowledge System (CKS) which may include the following core features:
Grouponomy
Member community features
Content Management System (CMS) features
Custom features for specific lines of business or industries

Solution Concept

Member Crossing will be a new kind of application that is best classified as a combination of a knowledge management system and a social networking site. We hope that it is the first in a new category of enterprise applications referred to as Community Knowledge Systems. The goal of Member Crossing is to determine the most innovative ways of facilitating an engaging community and storing and maintaining a shared body of community knowledge. Member Crossing will provide the following advantages to organizations
Conference-like community 24/7, 365 days a year!
Unified and centralized repository of community knowledge and resources.
Knowledge tools that scale well with massive stores of community knowledge.
New and innovative tools to help communities share knowledge.
An integrated classification system that helps to make knowledge more meaningful, discoverable and actionable.

Methods of Classification

Traditional classification approaches using formal semantic structures such as taxonomies or ontologies often require creating classes of things that are related in some type of graph. In most cases, a taxonomy forms a containment hierarchy where sub-nodes are more specific versions of their parent node. In ontologies, each node represents some resource that is related in some way to some other resource.

Since creating either a taxonomy or an ontology for a given domain of knowledge can be a time intensive process requiring an understanding of the rules of each form of classification, and since the chances of success for a solution in the new arena of community knowledge systems will be directly proportional to the simplicity of the system, we have developed a proprietary solution to the problem of soliciting group classification information called a grouponomy.

Introduction to the Grouponomy

The grouponomy will be at the heart of the Member Crossing Community Knowledge System and it will function like a shared, dynamic table of contents for a particular domain of community knowledge. The grouponomy is an aspect of Member Crossing that we believe is a new and innovative twist on the idea of a taxonomy. A grouponomy is simply a hierarchical classification system, like a table of contents, the management of which is crowd sourced to the membership of an organization. Another unique aspect of the grouponomy is the focus on each node in the grouponomy as a way to centralize all knowledge related to this particular subject or category. Unlike other taxonomies or ontologies, the nodes in the grouponomy may be of two distinct kinds: nodes to track real things and nodes to track categories of things. This new and unique form of classification was designed after months of research regarding the easiest way to provide a method of group oriented classification. The other unique aspect of the grouponomy is the way the group will contribute to the ongoing management of the community classification system documented, managed and referenced through the grouponomy. Whereas many Content Management Systems available today allow members of an organization to share information by creating pages in a site hierarchy or by contributing to forums, wilds, blogs, photo sharing applications and other social media oriented CMS applications and add-ons, Member Crossing will use the concept of the grouponomy to pull all of these disparate types of social media contributions together under the very specific contextual meaning associated with one or more nodes in the grouponomy. Rather than community data being distributed over thousands of forum posts, blog entries, comments, videos and other social media artifacts which are stored in a variety of disparate and disconnected systems, Member Crossing will provide a new and more centralized way of managing community knowledge. This new approach will help to add context to shared community knowledge artifacts, and this shared context will serve as the basis for more meaningful community connections which can be made as members of the community are able to see other members who have participated in areas of the system that are of interest to their specific areas of focus.

### BRIEF DESCRIPTION OF THE DRAWINGS

FIG. 1 shows the relationship between the slices and the grouponomy nodes. The basic idea that is being conveyed here is that with the grouponomy, users are encouraged to organize all of their knowledge related resources and artifacts around grouponomy nodes. Not shown in this image are lines from the Online Store or the Events custom modules which should be drawn between the Products Module as well as the specific node to which the slices are all relating. The unique concept here is the fact that grouponomy nodes allow members of the community to organize all of their disparate knowledge artifacts around the specific context of one or more nodes, where the hierarchy of the nodes is also managed by members of the group or organization using Member Crossing. The grouponomy, therefore, not only provides a categorization scheme for the community knowledge artifacts, but also provides the framework for quickly finding all of the artifacts associated with one of the nodes. In addition, and not represented in this figure, the idea of the grouponomy is unique in that each of the modules used to show specific slices of information related to a node may support the ability to view all of the down-level data in an aggregate format. So, on a specific node, I may be interested to see not only the products associated with that specific node, but also the products associated with all child nodes.

FIG. 2 shows a diagram representing one embodiment of the workflow that could be used when adding new items to a grouponomy.

FIG. 3 shows a diagram representing one embodiment of the process of discovering resources in a grouponomy.

FIG. 4 shows a representation of one embodiment of the interface for viewing the grouponomy nodes on the left and an example node in the center.

This figure shows a mockup of the main tab (the text module) for a grouponomy node. The purpose of this mockup is to show the way various types of information are grouped together in one location and related to a particular concept which is represented by the grouponomy node. This is a unique way to think about organizing community information. In other systems, such as Content Management Systems or even hybrid systems like SharePoint, the data related to a particular concept or idea is usually stored in various locations depending on the type of data being managed. Documents are stored in a document repository and images are stored in a gallery while videos may be stored in a resource center and discussions relegated to online forums. This makes it difficult for knowledge workers in an organization to find disparate types of information when they are working within a particular knowledge context.

FIG. 5 combines with FIGS. 6 and 7 to show one embodiment of an interface that could be used to add new resources to the system. This representation captures the fact that users will have a one-stop-shop solution for adding new items. This will help to simplify the process of adding items to the system.

Although the final implementation may be different, there are 3 basic phases to the process of adding a new resource that need to be captured:
Select resource type
Fill out resource details and optionally rate or comment
Assign to one or more nodes

FIG. 6 shows one embodiment of a second screen which might be used to associate a new knowledge resource with an existing node in the grouponomy using a hierarchical view of the grouponomy to find the appropriate node.

FIG. 7 shows one embodiment of a second screen which might be used to associate a new knowledge resource with an existing node in the grouponomy which uses a search interface to find nodes based on search terms.

### DETAILED DESCRIPTION OF THE INVENTION

Description of Grouponomy Features

Grouponomy Nodes

Each node inside of the grouponomy will be designed to store community information in a way that is more structured than most enterprise wilds. Each node may consist of zero or more modules which may be used to track resources related to each node. For example, a node on relational databases may contain an open text module for managing unstructured information about the node as well as modules for tracking bookmarks, surveys, products, events, bibliographies, associated professionals, forums or comments, blogs entries related to the topic, thesaurus style synonyms, ratings, photos or multimedia, classifieds, attachments, jobs and chat sessions. This list is not conclusive, but is meant merely to convey the different types of information that may be managed by the modules. Not all of these features will be available in the first phase of Member Crossing, but the infrastructure will be designed so that each of these modules may easily be snapped into the framework as they are developed. Of course individual clients will need specialized modules, so an open and well documented API will be provided along with detailed instructions on how to quickly create custom modules that will work within Member Crossing.

Our research led us to the conclusion that the best way to maximize discoverability and ease of use in the grouponomy was to simplify the process of adding content. This means limiting the number of choices for types of content to be added to the grouponomy to 2 in the first embodiment of the solution and to n in later embodiments where the n types of content may be organized under the 2 broad categories defined in the first embodiment: real things and categories.

Instead of trying to force members into identifying complex hierarchical relationships between the different classes in a particular knowledge domain, we concluded that the best approach would be to create a new classification tool which allowed users to form a classification system that is easily navigated based on things and categories of things. This form of classification may function like a directory which has little to no constraints regarding the type of content added to a hierarchical node. Working from the top down in a typical grouponomy, we expect there to be root level categories followed by nodes for real things to be categorized. These real things may be processes, disciplines, products, companies, best practices, etc. Under each node that constitutes a real thing, there will most likely be a layer or two of categories followed by other nodes which represent real things such as product features and sub-features. These real things may in turn have a variety of properties or features that may be organized first into categories and then finally into the actual properties or features. Consider the following example:

| Arts & Recreation | |
|---|---|
| Business | |
| Manufacturing | |
| Technology | −100 |

Microsoft
Products

| | |
|---|---|
| Databases | |
| Microsoft Access | |
| Microsoft SQL Server | −101 |

| | |
|---|---|
| Education | |
| Geography | |
| Legal & Justice | |
| Literature | |
| Medical (Health) | |
| Philosophy | |
| Religion | |
| Sciences | |
| Technology | −102 |
| Computing | |

Hardware
Software
Databases

| | |
|---|---|
| Enterprise SQL Databases | |
| Microsoft SQL Server | −103 |

```
Analysis Services
Integration Services
Management
Notification Services
Programmability
  CLR
  Stored Procedures
```

| | |
|---|---|
| Debugging | |
| Visual Studio Debugger | −104 |
| Meta Data | |
| Security | |

Reporting Services
Security

Games

Geological

The numbers to the right are strictly added to help identify specific nodes in the tree for discussion below.

The main thing we are trying to capture inside of the grouponomy is context for each node in the tree, and more generally context for data stored in the Member Crossing community knowledge system. From the example above, you'll notice the following things about the way the grouponomy will store information:
Nodes can be repeated. See 101 and 103 where the Microsoft node is repeated. When a node is added to the grouponomy, the system will check to see if the name assigned to the node already exists. In subsequent embodiments of Member Crossing, the system may also check to see if the name exists in any of the synonyms related to any of the grouponomy nodes and present these matches to the user as well. If a node exists, either by exact name match or through the future synonym match, the user will have the ability to choose to create a link to the pre-existing node, create a clone of the pre-existing node (without the children) or create an entirely new node.
Nodes can be related—as a member adds a new node and they are presented with a list of possible matches, the member may have the ability to associate one or more of these possible matches with the new node, regardless of the type of node that is created (linked, clone or new). These nodes may be related to the new node and may then be represented to the members viewing the node as related nodes. These associated nodes may also be used by the system to determine relationships between nodes and this may lead to an understanding on the part of the members regarding how the nodes in the grouponomy may be more accurately classified.
Categories and real things are mixed—Lets take item 104 as an example and show in breadcrumb fashion its lineage:
   Technology (category)->Computing (category)->Software (category)->Databases (category)->Enterprise SQL Databases (category)->Microsoft SQL Server (real thing)->Programmability (category)->Stored Procedures (category)->Debugging (category)->Visual Studio Debugger (real thing).

In the breadcrumb presentation of the node's lineage, the mixture of real things and categories allows the real things to have community defined context in the form of categories that convey information much like properties of an object or fields of a record in a database. In the first embodiment of Member Crossing, the system may use color to differentiate between the two basic types of nodes in the system. This will visually help readers of the node's fully qualified context to spot the real things in the data's context. Other embodiments of Member Crossing may use other visual clues to differentiate between the two main types of nodes. For example, it may be decided that bold nodes represent real things while italics nodes represent categories. In this case, colors could be used to visually identify the sub-types for either real things or categories.
Parent lineage conveys valuable information—for nodes in the grouponomy which are linked and which appear in more than one location in the hierarchy, there is valuable contextual information that is conveyed by the lineage of the node. For example, let's assume that Microsoft SQL Server from nodes 101 and 103 are linked nodes. This node would have two lineages as follows:
   Business->Technology->Microsoft->Products->Databases-Microsoft SQL Server-Technology->Computing->Software->Databases->Enterprise SQL Databases->Microsoft SQL Server
From this lineage alone, we can begin to put the categories and the real things together to note that Microsoft SQL Server is a product of Microsoft that has the following properties:
   Its parent company is a technology related business.
   It functions as an enterprise level database that is generally recognized as computing software.

Many more details related to the nodes and the rules that govern how the nodes in the grouponomy are managed by the group will follow; however, what we want to highlight here is that the grouponomy has been designed to strike an important balance between being full featured as a classification system and being tremendously easy to use.

Although the final embodiment of our new node wizard for the grouponomy may change significantly as it is being developed, we believe the core concept of guiding the user to think in terms of real things or ways to categorize real things will help ensure that the grouponomy that results will be far more useful than common directories that allow any type of node to be added. But most importantly, it will be simple and easy to use.

In future embodiments of Member Crossing, the two types of nodes in the grouponomy may be extended to provide the knowledge worker in a particular knowledge domain with more detailed types of things and categories. Nevertheless, even without this level of distinction, it will be possible to develop Member Crossing modules which will appear under a category to show all real entities that appear n levels down in the hierarchy. This may be helpful when creating nodes in the grouponomy to track people or places. For example, if Member Crossing were to be used by the Missouri Association of Small Business Owners (I'm pulling this out of thin air, so if this organization exists it is mere coincidence), they may want to create a node in their grouponomy for small businesses in Missouri. It might be subdivided as follows:

Missouri Small Businesses
By Region

Northwest
Northeast
Southwest
Christian County

```
Highlandville
Nixa
  Construction
  Manufacturing
  Technology
```

IT Crossing

Greene County
Southeast

By Entity Classification

```
Construction
Manufacturing
Technology
  Northwest
  Northeast
  Southwest
```

```
Christian County
  Highlandville
  Nixa
```

IT Crossing

Southeast

If I knew that my goal under the By Region node was to eventually track small businesses, then I would create each of the nodes up to the actual small business nodes as category nodes. This would allow me at any level in the category to include a module which showed all of the child nodes that were marked as real things, and eventually as more sup-types of real things are added, I could more specifically show all companies or small businesses, depending on the types of nodes that are configured in Member Crossing.

As important as this distinction between real things and categories can be, it should be noted that the distinction will be minimized as much as possible in the user interface in an effort to simplify the process of organizing a problem domain. We will achieve this by allowing the user to easily add a node without choosing one of the two types, in which case, it may simply default to a category. This is distinct from other classification systems which either require all nodes to be concept nodes where types may or may not have to be chosen or other systems which allow any type of node to be added without distinction.

As mentioned above, although the first version of Member Crossing may only allow two types of nodes to be added, these two types of nodes may be expanded in subsequent versions to allow each main type of node to support user customization. For example, for nodes of type thing, users may have the ability to define the modules to be associated with different sub-types such as organizations, products, features, services, ideas, questions, programs, individuals and groups. Furthermore, nodes of type category may also support customization at a sub-type level for sub-categories such as geographical, temporal and alphabetical as well as custom sub-categories that correspond to categories or properties specific to the problem domain. At their root, though, each node type may either be a real thing or a category. Breaking the real things and the categories into sub-types will just further simplify the process of adding nodes to the system.

For example, when the grouponomy supports adding a node that is a category and of a sub-type of temporal, the system may be able to suggest a predefined hierarchy that could be used. In this case, a wizard could be used to prompt the user for the timeframe being covered, and if the timeframe spans a certain number of years, automatically create time-based child nodes for each decade in the time span indicated. In other cases, the expected timeframe may be just a matter of weeks or months, in which case the child categories may be created as either weeks or months, again depending on the expected timeframe.

The differentiation between types of nodes in the grouponomy will serve mainly to expedite the process of adding new nodes into the grouponomy in a way that results in high degrees of discoverability for the user. Member Crossing may also support the association of zero or more class modules which will be defined in more detail below. If added, these modules will allow each node in the taxonomy to have class related data from zero or more classes to be associated with a particular node.

In order to ensure that each node can be easily accessed, each node will be assigned a unique URL which will never change. Nodes may also have more human friendly URLs that make it easier to share the URL with others. 301 redirects will be used to ensure that only one of the two URLs is maintained in search engine listings.

In addition to each node having a URI, the nodes will implement pingback or some similar technology to ensure that it is easy for people referencing the nodes from Member Crossing editors or from standard blog editors to link to a node in a way that allows the system to keep track of these links. These links may also be presented in the content associated with the node. This feature will make it easy for members to associate their blog posts with nodes in the grouponomy.

In addition to implementing pingbacks, each node will be addressable using a distinct URL, thereby allowing members to cc their website and have content sent to a specific node in the site. Another unique feature of the grouponomy within Member Crossing that will be described in more detail below will be built in support within the grouponomy modules for aggregation of content from child nodes. For example, if a user is viewing a node for SQL Server, the bookmark module may be designed to show not only all the bookmarks associated with the general SQL Server node, but also all the bookmarks associated with all of the child nodes. Users may have the option of either showing all aggregated information for the module or showing just the information associated with the current node.

One of the main goals of the grouponomy in Member Crossing is to allow members of an organization to easily collaborate on the definition of a semi-structured directory for their problem domain. In creating this shared directory which will function like a table of contents to their knowledge domain, members of a community will have the missing pieces that are needed to provide context to their data. We believe that the innovative approach described above to allowing an organization to build this grouponomy will help create a focal point within organizations for data that to-date has been discovered mainly through the power of search engines. And as more and more members of organizations turn to blogs for published content, the need to provide context to this rapidly growing body of knowledge is growing in direct proportion to the number of new blog entries added to the blogosphere each day.

Unique Identifiers

One way that the system will make it easier to organize data is through unique identifiers which will allow each node in the grouponomy to be referenced through a URL. As bloggers in a community write blog entries, either using their Member Crossing blog (if one exists) or using a blog engine of their choice, they will be able to easily associate their blog entry with a grouponomy node through the use of the node's unique URL. In order to achieve this, each node in the grouponomy will be assigned an immutable identifier which will be linked to a surviving node in cases where the node is deleted. The system may only support soft deletes so that deletions can be reverted. In the current embodiment, these IDs are designed to be short enough to be remembered by information workers. Accordingly, they may be around 6 characters in length and will be unique within a specific problem domain. A unique character or characters may be added to the identifier to ensure that should the grouponomy be implemented on a global scale, client identifiers will not conflict with other identifiers generated for the global use of this technology. An example of a client version of a unique ID could be:

CH238D7

Every node in the grouponomy may also have a unique trackback or pingback URL which contains the unique identifier and which can be used by knowledge workers using Member Crossing to easily associate resources such as blog entries to the node. This will allow the grouponomy to function like one giant blog where each node represents a blog entry that others can use to track or ping back. Each organization will also be encouraged to decide on a format to be used within documents for including the node ID when associating content with the node. For example, XYZ organization may chose to represent the node ID above in a document as XYZ_ID:CH23D7

This could be placed in any section of the document searchable by the organization's search engine. An example trackback URL for this same node could be as follows:

http://community.xyz.org/trackbacks/id/CH238D7.

The system may employ the use of more than one URL for each resource. For example, a node for SQL server may have the following human friendly URL:

http://community.xyz.org/technology/computing/software/databases/microsoft-sql-server/

and the following machine friendly URL:

http://community.xyz.org/CH23D7/

A 301 redirect could be used to ensure that search engines only index the content for one of the two URLs.

The purpose of each node will be to function as a repository for information associated with the node or the underlying child nodes. Some of this information may be in an unstructured format. For example, every node may contain a free text module which will allow members of the community to associate generic information about the node that can be stored and that would make sense being stored as HTML. These free text modules will allow users to add images and create links to both external resources and other resources stored within Member Crossing. Knowledge workers may be able to use the standard wild style syntax for adding new nodes to the grouponomy. For example, adding a reference such as [[Artificial Intelligence]] will cause a wizard to appear to prompt the user along in the process of creating a new node in the grouponomy with the name ‘Artificial Intelligence.’ Member Crossing may also support custom, extended information inside the tags used to reference a new node. An example of one possible embodiment of this idea is as follows:

[[Artificial Intelligence I Sibling I Company]]

This would cause Member Crossing to create a new page as a sibling to the existing page using the real thing sub-type of company. The page would be created with all the default modules assigned to the company sub-type.

Another possible embodiment is the following:

[[Artificial Intelligence |CH23D7|Product]]

This would result in a new page created as a child to the grouponomy node with the ID CH23D7. The page would be created as sub-type or class of product with all of the default modules assigned to this particular class of nodes.

In cases where a new page is referenced without including additional information to specify where the page should be created and what type or sub-type the page should be, the wizard may prompt the user to choose whether this is a real thing or a category and then further allow distinctions for sub-types if they exist in the system. The terms ‘real thing’ and ‘category’ may be changed to make the process as easy for the user to understand. As mentioned earlier, in other embodiments, this may take the form of two groups of choices with the group of ‘real things’ being further separated into distinct types of real entities commonly used within a given domain.

This list of different types of ‘real things’ and categories may be extensible by the client and each ‘real thing’ as well as each category may be configurable regarding the default modules that will be available for each node of this type when the node is created.

Every node in the grouponomy may contain up to n immediate child nodes, where n may be configurable by the client. In the preferred embodiment of Member Crossing, a node will not contain more than a dozen sub-nodes. We believe this will force organizations into defining levels of categorization that will increase the discoverability of grouponomy nodes.

While the main view of the Member Crossing community data may be a graphical representation of the hierarchical grouponomy structure, which in the first embodiment of Member Crossing may be a treeview, Member Crossing may also support viewing the data in the system according to each distinct module type. For example, users may be able to see all the entries in the tree that correspond to blog entries. The entire tree may be shown, but only the entries that contain blog module entries may be enabled. This will allow members of the community to quickly locate sections of the grouponomy which contain blog related conversations.

Related to blogging, the grouponomy may make use of technology similar to the current trackback technology used by blog modules to allow bloggers to easily associate their content with nodes in the grouponomy. In the initial embodiment of Member Crossing, the actual Trackback and/or pingback standards may be used along with a browser plug in which may take the form in the first embodiment of Member Crossing as a custom browser add-on, either in the form of a custom button, a bookmarklet, or a browser toolbar. Using the browser-based tool, content providers such as bloggers may have the option to quickly search the grouponomy of their organization to find a node related to their current topic. This tool, described in more detail below, will allow the user to quickly search the grouponomy based on either a singular term or a plurality of terms. The search may find matches based on the names of the grouponomy nodes as well as any synonyms entered using the module designed to track synonyms for the particular node. This will allow the user to see a set of matches from the grouponomy and allow the user to pick the matches that most closely apply. The end result of the user using the browser tool may be the generation of one or more URLs that will allow the user to associate their resource—which we believe will most commonly be a blog entry with the first embodiment of Member Crossing—with the grouponomy nodes chosen. These URLs can then be pasted into the resource being created to initiate a trackback connection to the grouponomy node. The URLs may be made available in both text and HTML form.

At the time of writing, the only resources known to support the Trackback specification are blogs; however, other resources, such as image sharing applications may adopt this same specification in the future.

Any resources added inside of Member Crossing by members may support connection to one or more grouponomy nodes. For example, if a user creates a blog entry inside of Member Crossing using the Member Crossing blog tool, the blog entry interface may natively support the association of the blog entry with nodes in the grouponomy. This may be the case for any resources that members can add to the system, whether they be images, audio recordings, multimedia presentations, screencasts, training courses, reviews, surveys, etc.

In addition to the ability to identify each grouponomy node, it will be a design goal of Member Crossing to have a unique URL for every resource or knowledge artifact that can be shared. This will allow things like blog entries, documents, videos and other social media items added to the system to be addressable through a distinct URL, which will make it easier for members of the system to share individual resources with other members.

Group Editing of the Grouponomy

An aspect of the grouponomy that is unique to Member Crossing is the ability for members of the community to govern the structure of the grouponomy over time using custom business rules to be defined by an organization. In the first embodiment of Member Crossing, there may be only a few simple business rules that govern a member's ability to manage the grouponomy, rules such as:
each participant must be a member of Member Crossing to make changes of any kind.
each participant must be explicitly granted access, either through their user account or through a group of which they are a member, through an assignment of said user account or group to a node property used to determine who has access to view the node. In embodiments of Member Crossing where this type of business rule is applied, the ability to view the node would cascade down through the child nodes of the currently selected node. each participant must be explicitly granted access, either through their user account or through a group of which they are a member, through an assignment of said user account or group to a node property used to determine who has access to edit the node. In embodiments of Member Crossing where this type of business rule is applied, the ability to edit the node would cascade down through the child nodes of the currently selected node.
each participant must be explicitly granted access, either through their user account or through a group of which they are a member, through an assignment of said user account or group to a node property used to determine who has access to change the structure of the node. In embodiments of Member Crossing where this type of business rule is applied, the ability to change the structure would cascade down through the child nodes of the currently selected node.
each participant can only revert a node n times within a 24 hour period of time, where n is configurable by the client.
changes made by participant are subject to audit and approval by either 1 or more specific members, or one or more members of one or more groups before being made public.

Member Crossing may be designed to support additional, custom business rules regarding the ability for a member to perform one of the following four operations:
Change the name of a node in the grouponomy
Insert a child node into the grouponomy
Move a node
Delete a node

In the first embodiment of Member Crossing, some operations may not be allowed. For example, if a member tries to move the child node of a parent node that is a linked node and the move operation results in a move to a new parent above the parent node, this may not be allowed in the first system. In subsequent systems, the system may alert the user that the move will have consequences in the other linked nodes. In this alert, the user may be given the choice of whether or not they would like to proceed.

Each operation that is performed in the grouponomy may be viewable through a history interface which may present the history of changes to a particular aspect of the system such as a page or a page module. Each operation may support the ability to revert to a previous state with the exception of some move operations made on a node in the grouponomy. In the first embodiment of Member Crossing, move operations where a node's former parent has since been deleted from the grouponomy may not support the revert operation. In subsequent embodiments of Member Crossing, the revert operation may show the entire chain of undo events required and may allow members to perform a revert to a deleted parent that will result in the re-creation of the old parent node.

In one embodiment of Member Crossing, the command pattern may be employed to keep a record of all changes made to the grouponomy. This may aid in the work required to support undo operations related to changes made to the structure of the grouponomy.

Although node splitting may not be supported in the first embodiment of Member Crossing, subsequent embodiments of the solution may allow members to pick a particular node and split it into one or more nodes, either as siblings or as children to the current node. These split operations will allow members to allocate the individual items stored in each module to one or more of the parents. Additionally, merge operations may be supported in subsequent embodiments of Member Crossing that will allow all module items to be merged from two or more nodes into one single node. When each of these operations occur along with any delete or move operations, a history of the unique IDs for each node may be maintained. This will allow resources that have been associated with an expired node or a node that has been merged or split to be associated with a current node in the grouponomy. This will help to address the issue of a grouponomy that will be in a state of flux over time. Although the grouponomy may be in a state of flux as users add data to the system, the IDs of every node ever entered into the grouponomy will be maintained for the life of the system with references pointing to the new location for content related to an old ID.

The fact that these IDs are maintained will help to mitigate the issues that often arise when data is in a state of flux. And because Member Crossing is designed to function as table of contents for a domain's data and not as a complete ontology, members of the community are free to create a wireframe structure around the terms and issues and ideas related to the domain of knowledge in a way that supports change over time without losing information.

In one embodiment of Member Crossing, an administrative interface is available to the members which provides the users with the ability to manage the organization of the nodes using common user interface interactions such as:
Drag and drop—If presented as a tree or using some similar graphical structure, nodes may be dragged and dropped to form a new hierarchical structure within the grouponomy.
Context menu edits—In this case, the member may have the ability to select a node in the grouponomy using an action such as clicking the secondary mouse button on some machines and cause a context menu to appear which could then present the user with a set of actions that could be performed on the currently selected nodes, actions such as:
   Insert Node Above
   Insert Node Below
   Insert Child Node
   Delete
   Rename
   Move
Some of these context menu options may result in a wizard appearing to collect additional information needed in order to complete the action.
In place editing of the name of the selected node by clicking the node to select it and then clicking it again to enter rename mode.
Additional interfaces which may not currently be described in this document.

After performing one of these actions, the system may either update the page immediately or require that other actions or states of approval be achieved according to the rules outlined elsewhere in this document.

In addition to moving nodes, it may be necessary to allocate the individual module items associated with each node. This may be of particular interest to members who have recently split a node into two separate nodes. In one embodiment of Member Crossing, module items will support move operations which will allow each module item to be either moved or copied to other nodes in the grouponomy. In addition, module nodes may support a soft delete, updates and an insert from this same interface in order to allow members to have full control over adding, deleting, updating, moving and copying module items.

Rules for Changing the Grouponomy

In the initial embodiment of Member Crossing, the rules regarding when a change can be made to the grouponomy may be as simple as whether or not the user is a member with appropriate privileges to make said changes to the grouponomy node in question.

In this or later embodiments of Member Crossing it may be possible for authorized members such as administrators to define more specific rules regarding conditions that must be met before changes are allowed to the grouponomy node. Conditions such as the following could be employed:
Changes are only allowed after approval of some group of members for the entire portal
Changes are only allowed after approval of some group of members for the node in question, the group of members to be defined by an actual role or group within Member Crossing
Changes are only allowed to a node after n or n % of the active members approve the changes. This would require an interface which would show the requested changes and allow members to vote on these changes.
Changes are only allowed when n or n % of the most active members of the node approve the changes. The active members could be defined for the node or the node and all of its child nodes.

Grouponomy Node Types and Classes

The grouponomy nodes may initially be of two types: real things and categories of real things. Another way to describe this would be folders and objects. Subsequent versions of Member Crossing may extend these two types to include sub-types, thereby allowing nodes in the grouponomy to be differentiated by more specific types. In addition to this sub-typing, the grouponomy may additionally support the ability to associate class modules with a grouponomy node through composition.

Although the first embodiment of Member Crossing may not support this feature, subsequent editions of the product may allow the use of a class module for associating pre-defined properties with a particular node. This module may function as a kind of class module which may allow a predefined set of properties to be presented to the user. Another way to describe this module is that it may function as a custom form module where each form will be labeled or associated with zero or more classes and each class will simply be a definition of the fields that will be tracked on the form. Members of the system with the appropriate levels of permission may have the ability to define the properties of a class along with their data types, default values, and validation rules such as whether the field is required or whether it should match a particular regular expression. These fields may also be defined as storing values from lookup lists defined by the system. The system could have an interface to allow members with sufficient privileges to edit the contents of these lookup lists. These properties may support all of the standard data types (such as Boolean, String, Decimal, Integer, DateTime, Time, etc). A given node in the grouponomy may have the ability to be associated with zero or more of these modules allowing content to be classified according to multiple classification schemes.

One possible embodiment which is being considered for a future version of this module—which we'll call for now the class module, realizing that the name will most likely change based on usability studies—is a version of the module which may allow for composition of the distinct classes available in the system. This may allow for reuse of the classes. An alternate version which uses inheritance is also being considered.

In either case, the embodiment of this future module will be a module which allows members of an organization to create a method of classification that functions orthogonally to the classification available through the grouponomy. The grouponomy may be the main vehicle for classification with the class modules functioning as a way to apply more structured classification to each node as it is needed by the community. Members of the community with an appropriate level of access may be able to manage the properties associated with each class defined for the class module.

Although the purpose of these multiple levels of classification may not be to form an ontology, future embodiments of Member Crossing may be extended to include interfaces which make the data in the grouponomy available in some combination of RDF and OWL formats.

Member Crossing may be designed to allow organizations to create zero or more groups. These groups may function as security boundaries when defining access control to nodes in the grouponomy as well as to modules added to a node and to module items available within a node. Groups may also function as the vehicle for:
sending email messages to groups of users
inviting other members of the community to chats
sending invitations to events.

In short, any action that will require that an operation be performed for more than one Member Crossing account may be a good candidate for using one of the groups. Groups may be grouped in the system into group types based on the default functionality of the underlying system that is planned for the first embodiment of Member Crossing, however, these group types may not be useful as vehicles for performing operations with more than one account. Group types may function in the first embodiment of Member Crossing as an organizational tool to quickly find a group. Also, groups may not contain other groups; rather, groups should only contain users. Later editions of Member Crossing may support the ability to have nested groups, that is, groups that contain other groups or members.

In the first embodiment of Member Crossing, access security may only be performed by adding groups that should have access to the resource in question. Subsequent embodiments of the solution may also allow for groups to be included that should not have access to a resource. The two items that can be assigned to an access control list for a resource may be individual user accounts as well as groups of users.

Access control lists may be available for grouponomy nodes, node modules and for module items. Whether or not there are access control settings at the module item level will depend on the module.

Ability to Create Multiple Grouponomies

An instance of Member Crossing may support multiple instances of grouponomies and the name and marketing of each grouponomy may be configurable by the administrators of an organization. This will allow members of one organization to market the use of the grouponomy as a workspace while the members of another organization market a similar use of the grouponomy as a knowledge base. Organizations using Member Crossing may choose to include as many grouponomies in their site as they wish with each instance of the grouponomy given a separate name. All nodes added as children to a grouponomy node will be constrained to either things (or subtypes of things) and categories of things (or subtypes of categories).

Member Crossing Templates

Member Crossing may be marketed and sold to a variety of industries to be used in a variety of ways. While there will be a core Member Crossing engine which will support its use as a Content Management System (CMS), a social media platform and a knowledge management solution, these 3 core aspects of the Member Crossing engine may be combined with custom modules to create a community knowledge system with features specific to a particular industry. Templates will be created for uses of Member Crossing in contexts such as the following:
CMS—The administrative interface will permit administrators and content providers to use the Member Crossing as a CMS within their organization. When used as a CMS, the interface for adding new nodes to the site hierarchy will allow members with sufficient privileges to choose initially whether they want to add a new page or a new grouponomy. It should be noted that the term grouponomy may be replaced by a different term in the final marketing material for Member Crossing. Once a grouponomy node has been added, the interface used to prompt a member through the steps needed to create a new child node will restrict the member to the two broad sets of choices already described above: things and categories of things. The default for regular CMS nodes will be for everyone to have view access and only site administrators to have edit access to these pages. This may be overridden by site administrators. Users with edit privileges to the grouponomy pages may have the option to allow some nodes in the grouponomy to be edited by the other groups and members. Similarly, members with appropriate permissions may have the ability to allow only certain members or groups of members to have view access to a grouponomy node and its children. Permissions may be overridden at any level, regardless of whether the page is a grouponomy node or a CMS page in the site.
Community Knowledge—The community knowledge template may be designed to make using the grouponomy as easy as possible. While the CMS features may still be available through the administrative interface, when adding new items to the portal, the system will present only the choices for adding grouponomy nodes. The ability to add a regular CMS page may be available through an advanced interface.
Project Workspaces—Project workspaces may be separate portals designed to use the grouponomy infrastructure along with custom modules needed to facilitate project oriented coordination among team members. The creator of a project workspace may function as the administrator and may be able to populate users and groups from main portal. Project workspaces may be child portals off of the main parent portal.
Event Communities—Event communities will be similar to project workspaces, but the security may be configured based on an import of users from an event management application. Only members who have the right to participate in the event community may have access to the community features of the event community. The event community may be based on the same grouponomy infrastructure as all baseline Member Crossing applications. Event communities may have additional modules designed to show who has registered for each of the tracks and sessions in the event. Tracks and sessions may be configured as grouponomy nodes for the tracks and child nodes for each of the sessions. Although the default security settings may be changed, each event community may be designed to restrict access to only members who have paid for some part of the event. Additional features slated for the event communities include:
   Integration with Event management software
   Show registered attendees before and after event
   Private access to multi-media content
Global or Industry-Wide TOC—Member Crossing could be configured to be used by the members of an industry of for the Internet at large to provide a grouponomy classification of the knowledge either in that industry or available on the Internet. ITCrossing.org may be powered by the Member Crossing grouponomy engine in an attempt to provide the IT Community with a free community site where a semi-structured directory made available through the grouponomy would provide context for the growing knowledge base available through the blogosphere. If a global version is launched, it will contain a reduced set of modules. The focus of the site would be simply to use the grouponomy as a way to create a global table of contents for the data about which people are blogging or are otherwise contributing resources that can be related to other resources either through the trackback protocol or some similar technology.
Custom Communities—The Member Crossing grouponomy infrastructure will be used to create a variety of custom community portals. Examples of the types of community portals that are planned are:
   Church Web Sites—this will be a custom implementation of the CMS model defined above with custom modules defined for churches such as prayer requests, member needs, etc.
   Chamber Sites—this will be a custom implementation of the CMS model with modules defined specifically for chambers of commerce. Some of the core modules available for chambers will be a custom business directory module as well as a custom event registration module.
   Community Portals—Similar to the chamber site.
   Family Sites—this will be a custom implementation of the CMS model with special modules created for families such as a recipe module, a genealogy module and a family reunion event registration module.
   Workgroup Edition—an edition based off of the project workspace model with a user limit of 5 to 10 users. This model will be hosted and will sell for a monthly fee along with free versions for open source projects and for non-commercial use.
   Reunion Edition—based off a template similar to the Church Web Site portal, this edition will contain a custom event registration module along with special modules to be included on each members profile page which highlight the clubs and activities each member was involved in while in high school.
   School Edition—Similar to the Church Web Site edition in that it will provide community features. However, the school edition will have extra features to facilitate classroom community.
   Alumni Edition—for alumni of educational institutions or organizations such as fraternities and sororities.

Grouponomy RSS Integration

Almost every aspect of Member Crossing will be accessible through an RSS feed. This may include:
RSS Feeds at the module level
RSS Feeds at the page level which aggregate any of the RSS changes from any of the modules in the page.
RSS Feeds per page for just the text content on the page.
RSS Feeds for individual threads in the discussion forum.
RSS Feeds for module items which have comments enabled.

Member profiles may also have the ability to subscribe to RSS feeds and view the feeds within their profile. A module may be made available to members which will allow them to aggregate their organization or industry related news in one place.

Additionally, Member Crossing may use RSS to keep a member's content stored in other tools synchronized with their profile. In the interface used by the members to manage their profile page, members may have the ability to associate zero or more RSS feeds with their profile. These feeds will be accessed either on a schedule or based on demand by the user. When users choose to select an RSS feed, they may have the ability to select the type of content being added to the member's profile. The Member Crossing system may parse each page looking for the presence of URLs formatted according the conventions to be used by Member Crossing to identify content within grouponomy nodes. These conventions for the URL may stipulate that custom formats be used inside of the URL such as with the rel attribute or through the use of QueryString parameters which will associate the resource in the URL with a specific grouponomy node as well as a particular slice associated with the grouponomy node. The presence of said URL or URLs in the page will allow the Member Crossing system to associate the resource with the appropriate grouponomy node or nodes as well as to one or more modules in the node which represent slices of data to which the resource has been linked through the custom formats mentioned above.

Grouponomy Modules

As has already been described, the grouponomy will contain a variety of modules that will serve to provide structure to the different kinds of information or resources that may surround a particular topic in the grouponomy. The different types of modules fall into at least 5 basic categories: Describing, Sharing, Requesting, Connecting, Rating and Listing. The following list of modules in each of the categories will provide a short description of how each of the modules will be developed to fit within the Member Crossing grouponomy infrastructure. Unless otherwise noted, each of the following grouponomy modules will support tagging, comments, rating, aggregation and group level security.

While the ability to manage a hierarchy and add modules to pages in the hierarchy is not unique to Member Crossing, the ability for the modules associated with a grouponomy to support content aggregation based on that hierarchy is distinct to Member Crossing. We believe this feature will greatly enhance the meaning of the information stored in the modules that are associated with grouponomy nodes throughout each of the levels of the grouponomy hierarchy. As members move up and down through the hierarchy, the aggregated view of information associated with each node will provide multiple perspectives on the data, much like zooming in and out of an online map provides different levels of context for geospatial data. In fact, with some modules which track geospatial data, maps will be used to aggregated views of data related to a node.

Users may have the ability to choose whether they want to view aggregated information for nodes where node administrators (by default, the account who created the node as well as site administrators) may have the ability to configure the module to make aggregate information available.

For nodes where aggregate information is available, the details for all nodes below the current node will be shown in the item listings for the modules. For example, if the module in question is a bookmark module, then the aggregate view of the bookmarks for a particular node will show all bookmarks assigned to this node as well as all bookmarks assigned to all nodes below the current node. As noted elsewhere, Member Crossing may also provide a means for either the node administer or administrators to choose the specific nodes that should be included in the aggregation.

For pages that are linked, Member Crossing may provide the means to have an item associated with specific instance of the linked node or to optionally assign the item to all instances of this particular node. Member Crossing modules which support aggregation may also provide an interface allowing users who are viewing a particular node to see all items associated with the same node that is linked elsewhere in the site. This will allow members to view data associated with a module which supports aggregation from a variety of different angles. For example, if a node was added called Hiring which contained a generic description of hiring best practices, and this node was linked to nodes for specific stores around the country which are grouped into regions, then a Bookmarks module which supported aggregation could be used to see bookmarks related to hiring added by the staff of a single location or they could see all bookmarks added for an entire region, or, finally, they could choose to see all bookmarks related to any of the Hiring pages used throughout the system, whether they were linked as a child not to a location or to some other type of node entirely.

Describing
Thesaurus—the thesaurus module will allow members to provide synonyms for each node in the grouponomy. In the rest of the document, the word “synonym” may be used to reference this functionality. In the first embodiment of the solution, the synonyms for the node will be shown. In other embodiments of the solution, the thesaurus module may also show synonyms associated with any of the module items listed for that node. For example, if the node is for the topic bullying, the synonyms added for the node may be aggressive and terrorizing, while content such as blogs or URLs associated with the node may have also been associated with terms such as pushing, shoving, hitting and shouting as well as a variety of terms that may be loosely related such as counseling or friendship. These two lists of terms may be shown separated with the former being editable (the synonyms and the latter being a read only listing of the words).
Class Module—The class module will allow for a predefined set of classes to be defined by the community. The definition of each class will define the class name as well as a list of properties related to the class. The actual class modules that are associated with a grouponomy node will allow the user to enter values for each of the properties associated with the class. For example, an address class could be defined with properties such as Address1, Address2, City, State and Zip. Whenever a class module is added to a node and the type of the class module is set to address, the module will allow the user to enter values for the fields listed above. Each property will be defined according to its data type as well as whether it is required and whether there is a validation regular expression associated with the property. Members with appropriate privileges will have access to an interface which will allow them to modify the properties related to a class.
Free Text—the free text module will allow members with appropriate permissions to edit HTML which will be shown to the members when the content isn't being edited. This free text module will be designed to understand a modified form of the standard wiki syntax for adding or referencing pages within the site. Possibilities regarding the syntax have been discussed above.

Sharing
Blogs—All blog entries created within Member Crossing will have the ability to be associated with zero or more nodes in the grouponomy. In addition, any blog entry that includes a hyperlink to the trackback URL for the node will appear listed in the list of blog entries. Blog entries listed under the blog module will have a rating interface which will allow members to vote the blog entry up or down. An algorithm will be developed to sort the blog entries based on the number of up votes per/day. Members will only be able to vote a blog entry up or down once.
In one embodiment of Member Crossing, the blogs may be shown by blog as well as by individual entry. This will provide the user with a way to see the most popular blogs at a glance. This feature may be implemented by simply providing a grid-like view of the blog entries that can be grouped by blog.
Discussion—the discussion module will operate initially very much like a threaded discussion forum. In the first embodiment of the solution, the discussion module will function as a simple threaded discussion. In future embodiments of the solution, the threaded discussion module will be augmented to allow users to add varying types of threads. Examples of some of the different types of threads that may be supported are:
   Problem/Solution—When this type of thread is chosen, the thread represents a problem and solutions to the problem may be noted in ways similar, but not limited to, the following:
      Either the members or the author of the thread can choose which is the solution recognized by the community. In some cases two answers may be highlighted as the solution, one chosen by the author of the problem and one chosen by popular vote. It may also be possible for the author of the question to choose more than one good answer, thus providing for n answers selected as the solution.
      Answers are sorted based on popularity and the community decides which of the answers floats to the top. Popularity could be based on:
         The total number of votes
         The total of +− votes
         The total # of votes received over a period of time (n day moving average).
      It may be that a combination of these approaches is used in order to solve a common problem with vote or hit-based popularity ranking. The problem stems from the fact that older answers which have had more time to accrue popularity ranking are placed above younger answers which may be better but may not receive the focus of the community because they were entered late in the game. Allowing the person who submitted the question to choose 1 or more answers that meet the criteria of a useful answer to the problem may help to mitigate the issue of some answers receiving more popularity simply based on the amount of time they have been posted.
   Question/Answer—Similar to problem and solution, but listed as a Question.
   Bug/Workaround—Similar to problem and solution, but listed as a Bug
   Suggestion—Members are allowed to make suggestions related to the selected node.
   Comment—Comments related to the selected node.
   Thought—Similar to comments, only flagged specifically as a thought to elicit the feedback of other members.
   Complaint—Members are able to log complaints related to the selected node.
   Wish List—The wish list would function as a way for members to provide feedback products or services related to the selected node that would be helpful. For example, if the current node is labeled SQL Debuggers and a member visits the node only to find that there really isn't anything listed, the member could add an entry to the wish list for a product that would provide excellent SQL Debugging.

The threads in the discussion may support rating and may additionally be grouped based on the thread type. Combining these features would allow members to group by thread type and view the most popular threads first. This would help members quickly identify, for example, the most popular questions.

Visual clues, either through icons or the use of color will help differentiate between the different types of discussion added to the nodes.

While in the first embodiment of the solution there may not be email integration with the threaded discussions, there may be RSS syndication available for the entire module and for each thread as well as email integration allowing members to subscribe to the entire node or to a specific thread. When members sign up for email notification, members may have the ability to receive notifications related to any forum for the current node and all child nodes. Additionally, members may have the ability to subscribe to a daily, weekly or monthly digest version of:
A node
A node and all its children
A specific thread

In an embodiment of Member Crossing where nodes can be identified as a sub-type of real thing such as Product, this data in the discussion forums will become useful to vendors associated with products. For example, if a version of Member Crossing is used by the IEEE and a particular software vendor is listed in the grouponomy under a Product node that contains an active community of members who are regularly posting bugs and workarounds, it may be of interest to the vendor to have an avenue to address the issues so they are not entered into an industry-wide database. This would provide a way for the IEEE to make additional revenue from the use of Member Crossing. Members of the organization could pay to have access to the data from threads marked as complaint, bug, wish list or suggestion. Additionally, vendors may have an interest in an additional module that may be developed for IT Crossing, an issue tracking module which would be available to any vendor willing to pay a fee for the use of an external interface to their issue tracking data.

In the main page for the discussion slice, there may be an additional forum for discussions not related to any of the grouponomy nodes. These additional discussions may be presented as a plurality of forums with possible forums such as:
Café—Or some other similar forum where members are encouraged to share information that is miscellaneous in nature.
Idea Share—a place to share ideas that may or may not be related to a specific grouponomy node.

Threads in each of these discussion forums may be assigned to the discussion related to a particular grouponomy node if after the discussion has started members realize that the topic would relate to an existing node. Members may have the ability to move the thread or create a copy of the thread under the grouponomy node.

List Module—List modules will be added to allow members to create their own lists. These lists will allow the user to define the type of tabular data they want to show. In the first embodiment of this module the list items may not support up/down voting on the line items and it may also not support sorting. In subsequent embodiments of this module, the lists may support aggregation. For example if a node named Volunteer were to contain child nodes for each of 4 main regions inside a state and each region were to contain 5 to 10 nodes for specific volunteers and each volunteer node were to contain a list module listing the skills for that volunteer, a list module could be added to the Volunteer node which showed a listing sorted by region and by volunteer of all of the skills of all of the volunteers in all 4 of the main regions.
News—Members would have the ability to write short descriptions of a news item in HTML that would be listed and voted up or down by other members. News stories would be sorted either by date or by popularity where popularity was determined by a custom formula which would represent the average up votes over a predefined period of time. News items would also be added through the browser toolbar. The browser toolbar would simply make an HTTP post to the trackback URL along with the HTML added for the news entry. The browser toolbar would provide a quick and simple interface for adding a news entry in the browser while reading a page.
Images—Depending on the edition of Member Crossing, photos will either be uploaded to the site or will be referenced from external sites such as Flickr or YouTube. In future versions of Member Crossing, there may be a custom browser toolbar interface for easily adding references to images to the site from external sites. Both images that are uploaded to the site as well as images referenced from external servers will be shown in the module. In the first embodiment of the solution, the images will be shown for only the selected node. In subsequent embodiments of this module, images from child nodes may be visible by making a user interface selection, such as checking a checkbox, to note that all child images and media should be shown as well. This may result in an AJAX call to the server to retrieve the images from all child nodes and may be presented as a series of child nested galleries. The images module and all modules like it may support rating, tagging, comments, group level security and aggregation.
Video—Similar to the images module, only designed to show video.
Audio or Podcasts—The audio or podcasts module will be similar to the images module, but designed to present audio files.
Documents—Depending on the version, documents may be uploaded to the site. Uploaded documents may be stored in a single folder on the web server, but the filename will be prefixed with the ID of the node to ensure uniqueness of file names. Documents may also be referenced from external file locations that are known to be accessible to all members who would have access to the node. In future embodiments, it may be possible to see all documents for all child nodes, again by making a user interface selection which noted that all child documents should be shown.
URLs—URLs will be associated with specific nodes through a browser toolbar which will provide an interface for bookmarking an URL. This interface will allow the member to quickly locate one or more nodes in the grouponomy to which the URL should be associated. Users will also have the ability to provide tags or synonyms for each association.
Spreadsheets—Either provide a way to easily link to or integrate external spreadsheet applications, or use a third party control, or build a spreadsheet module in-house in order to provide members the ability to save spreadsheet data related to a grouponomy node. In the early embodiments of Member Crossing, this may be achieved through adding spreadsheets to the document repository.
Tools—This module will be used to share common tools, software or otherwise, which the community has found useful related to the particular node. In one embodiment of this module, the module will track the name of the tool and a URL to the tool. The module may support aggregation, rating and comments.
Training—This module would provide access to training materials related to the particular grouponomy node. This module may support aggregation, rating and comments.
Presentations—This module would allow members to associate presentations with a specific node in the grouponomy. Each presentation entered may contain multiple files as well as a short description of the presentation. This module would support aggregation, rating and comments.
Humor and or Puzzles Module—This may also be implemented as a custom module. A humor or puzzle module would allow members to share humorous or thought provoking items related to a node. If used as a custom module, the module would allow members to share in one central location items that are humorous or are related to fun puzzles for the group to solve. This module would support aggregation and rating. Including a module such as this would provide an avenue for members to share light hearted items and having a place for this type of content would help to keep the content stored in other modules more focused.
General Requests—This module could be extended to be used for multiple purposes by different types of organizations. One use of this may be to provide a means for members to share prayer requests if used by a church. Another may be a module used by a community to share individual or group related needs. This module could support aggregation as well as features which allow people to easily mark requests as answered or resolved.

Requesting
Surveys—This is a unique social networking feature. The Surveys module is a module which allows members to quickly and easily create survey questions. Members will be allowed to create questions and add them to the list of survey questions related to a node. Each survey question will have up down ratings to provide for sorting based on the distinct up ticks over time method noted above. Members will have the opportunity to fill out a survey only once and after filling out the survey, the member will have access to the results. Just as with images and documents, an interface will be created to all the users to see all surveys for the current node and all child nodes.
The survey module could be enhanced to allow some survey questions to be defined for a group or for a list of members where either all need to complete the survey or n of the group need to complete the survey or some percentage need to complete the survey. When this feature is used, the UI may be updated to show the people who have responded and how they've responded as well as the people who haven't responded. The survey module may provide additional interaction with the list of vendors maintained in Member Crossing in such as way as to allow members to purchase the ability to create surveys that are directed to either the entire list of members, or to members associated with either groups or grouponomy nodes. The vendors could have the ability to purchase either a set number of survey responses or to purchase a period of time which the survey could be available to the group of members chosen. A few of the different pricing models that could be supported include but are not limited to:
   $n/response with a limit of $x for the entire run. The survey would end after the receipt of the number of responses necessary to equal $x.
   $n/period of time that the survey is made available
   In addition to determining the type of pricing as noted above, portal administrators may have the ability to define the target group for the survey based on factors such as, but not limited to:
      Membership in zero or more groups
      Lists of members defined by a query of the membership profile data based on zero or more profile properties.
      Relationship to zero or more grouponomy nodes, with the type of relationship defined as noted elsewhere in this document.
Tests—The idea here is to create a module that members of an organization can use to create one or more tests related to a particular node. Each test could have one or more questions. This would be similar to the survey module with the exception that questions could be grouped, specific answers would be defined for each question, and test would need to be graded. In one envisioned embodiment of this solution, the test module could be made available to public users as well.
Test questions may support rating, thereby allowing members to view the most reliable questions first based on their rating.
Q & A—This module would allow members to post questions as well as potential answers. The best answer would be determined both by the author of the question as well as through up down rating of the responses. This would mean that it would be possible for an answer to be both the one chose by the author of the question and by the majority of readers. Additionally, questions themselves will support up/down voting so that the questions can be listed either chronologically or by the custom method described above where calculations are made on the up ticks over a set period of time.

Connecting
Related Members—The related members section would be broken up into discrete sections showing the following kind of information:
   Members who can be contacted regarding this topic
   Members who have contributed to this node.
   Members listening to this particular node.
   Groups who have access to the current node. Each group may be selected in some way to show the individual members in the group.
Users will appear in a way that allows the current user to select the user in some way, such as clicking a hyperlink, to see the user's profile. Each user's profile will have a user interface element which will allow the member to save a connection to that user at some level defined by the XFN standard and including a level for just bookmarking a person. Additionally, it may be possible in a future embodiment of the solution to categorize the contacts marked to be bookmarked.
As has been noted earlier, this data could be presented for the current node only and a particular user interface element could be added to allow members to easily show related members for the selected node and all of its children.
In addition to the types of members listed above, the related members module may additionally provide a means for creating zero or more hierarchical groups of members related to the node. This could allow administrators or members of a group to denote different positions within the group of members related to the node. An officers group, for example, may be created to allow specific members to be listed as officers of the group.
Chat—Chat is often one of the most unstructured mediums for group communication. In one envisioned embodiment of Member Crossing, the chat feature is configured to allow easy association of a chat with zero or more nodes in the grouponomy. Additionally chat may be configured to allow only members of a particular group to participate in the chat. In the first embodiment of Member Crossing, chat may not be integrated with the grouponomy, or it may be included separate from the grouponomy, either as a shout-out kind of a feature or as an independent chat module which allows members to chat with other members or to create chats which include everyone in a particular group.
Groups—The groups module will show the groups that have access to the current node. This module will only show when users have selected a user interface element noting that they would like to configure custom security for the current page. In some embodiments, this may take the form of a checkbox with a label that says, “Security Settings.” Activating this user interface element may cause a new user interface to appear which may allow the user to select zero or more groups and define whether each group should have read or edit access to the node. This new setting may propagate to all of the children unless overridden at the child level in the same manner or unless the child is a linked node. In the cases where a child is a linked node, the permissions will be determined based on the settings assigned in the context of the original node. In the first embodiment of Member Crossing, everyone with access to view a node may have access to configure the security of the node. In subsequent embodiments of Member Crossing, this privilege may only be granted to either specific members or members in one or more groups.
Who's Online—The who's online module will show the total number of members online at any given point in time.

Rating
Rating—The rating module is distinct from the up/down rating user control that will be developed for the module level items. The rating module will allow nodes in the grouponomy to be rated on n different items to be configured by the portal administrator, where n must not be greater than 5. While this will be configurable in subsequent versions of the product, in the first embodiment of Member Crossing, the following 4 areas will be available for rating each page:
   Is it the right level of complexity?
   Is it complete?
   Is it well organized?
   Is it relevant?
In addition to restricting the number of rating questions, rating questions will have no more than 5 levels of rating with the preferred number being 3. Since this rating module can be added to any page, it will provide a way for site administrators to allow any page in the site (if Member Crossing is used as a CMS) and any node in the grouponomy to be rated. Of the five rating questions above, two—complexity and relevance—would require a different interface from the others. In the first embodiment of Member Crossing, the rating interface will most likely be implemented with slider bars. Each slider bar will be set initially to the best possible setting. For the useful, complete and organized rating questions, this will most likely mean that the slider bar is all the way to the right. For the complexity and relevance questions, the slider bar will be set to the middle noting that the article is at the right level of complexity or relevance. If set to the right or to the left, this will denote that the page or node in question is either too complex or too simple, spot on or not too relevant.
In addition to the rating questions, the rating control should provide a small area to be used for adding text comments.
In one embodiment of the rating solution, the rating control will be placed in the lower right hand corner of the screen and may use a visual setting such as opacity to reduce its visual presence. The control may show n columns corresponding to the n different ratings aspects and may show the current rating for the n different columns in a chart form. When the user hovers their pointing device over the rating control, an interface may become visible showing a way to quickly rate the page as well as showing a way to add or view comments. The comments added to the rating control may be added to a special thread in the discussion called rating comments to allow conversation related to the comment.
In another embodiment of the rating control, the control will be shown with a simple rating scale that will rate each of the distinct rating categories equally. Upon moving the mouse cursor over the control, the user may have the ability to view the distinct ways in which this resource can be rated. In addition, the user may be able to see an interface for adding comments. The key in this embodiment will be the balance between the simplicity of rating the item quickly and the advantage of rating the item in a more detailed manner if time permits.
Comparison—The comparison module will provide members with the ability to compare products under a specific node. For example, if the selected node is labeled ORM Frameworks, a member would have the ability to add a comparison module which would appear as a table with columns and rows. The rows would correspond to products (or anything else being compared) and the columns would correspond with features that members of the community would like to compare, where both the columns and the rows are configurable by members of the community. The cells would also be editable so that members would have the ability to select levels of support for each feature/product combination.
In the first embodiment of the solution, this will take the form of a table which can be edited by members of the community. In future embodiments of Member Crossing, this module may be extended to quickly search through the children of the parent node n levels deep to find nodes associated with class modules of a particular type. The properties and values of the class modules would then be scanned and the comparison generated based on the data stored with each product.
This conceived future version of the comparison module could allow for bi-directional updates, so that if a member were viewing the comparison module for ORM Frameworks and they were viewing the row for SubSonic and noticed that under the column labeled ‘Supports Stored Procedure Generation’ there was currently no support listed, they would have the ability to edit the column and thereby update the data stored in the class module related to the SubSonic node in the hierarchy.
The data gathered in these comparison modules could be mined to create reports that would be of significant interest to vendors. For associations and non-profit organizations using Member Crossing, this could be a source of revenue for the organization.
Issue Tracking—As mentioned above, for nodes related to products or services provided by a specific vendor, members of the community would have the ability to use a shared issue tracking module to communicate openly with the vendor regarding outstanding issues. The issue tracking module could be a modified version of one of the open source issue tracking packages.
The goal of the issue tracking software would be to get the issues related to a product or service out into the open for a community. So often, these issues are managed quietly either directly with the vendor or through user groups. This makes it easier for vendors to provide unacceptable levels of service. Initially, there would be some resistance on the part of vendors to make use of an open issue tracking tool like this, but all it would take is for one vendor in a particular niche market to put their issue tracking on the line as a statement that they have nothing to fear and then all the other vendors not participating would look like they have nothing to hide.
This module would help increase the level of service provided by vendors over time since they would know that unacceptable responses to outstanding issues would be seen by a much larger audience.
The issue tracking would also need to be designed to support aggregation of issues at lower levels in the grouponomy. For example, if the selected node is Microsoft SQL Server, there will most likely by 2 or 3 levels of child nodes documenting the different features available in the product. For each feature, an issue tracking module would be included in the node to allow issues related to that specific feature to be recorded. The issue tracking module shown at the Microsoft SQL Server parent node would show an aggregate view of all of the issues for all of the features available under Microsoft SQL Server.
The issue tracking module could be configured to allow community resolution and or vendor resolution to an issue. Each line item would list information such as the following:
   Issue Title
   Issue Type (Types such as Enhancement, Bug, etc)
   Issue Description (HTML)
   Assigned To
   Created By
   Comments
   Attachments
   Resolution
   Resolved By
Books—This could appear under sharing as well. The books module will be configured to allow members to easily share books related to the selected node in the grouponomy. In the preferred embodiment of this module, the member will engage a section of the user interface to initiate the process of adding a new book. This will cause an interface to appear which will allow the member to search for the book through an interface such as the library of congress catalog using web APIs or through a commercial interface such as Amazon.com. Since some publications may be available only privately through an organization, Members will have the ability to enter the information related to their book manually.
In one embodiment of this solution, the book module will allow members to link to the book if there is a node in the grouponomy related to the book. This will result in the use of some kind of user interface element which will allow the member to quickly navigate to the grouponomy node related to the book.
Similarly, in cases where an organization is using an online store component, either third party or provided as a part of Member Crossing, the books available for sale in the store will be available in the search results for linking.
Each line item will contain a rating control previously described which will allow members to rate the books up or down and also provide comments.
Products—This could appear under sharing as well. The products module will be similar to books. Its purpose will be to allow members to maintain a list of products related to the selected node. Products will support rating and there will be an interface that will allow members to add basic information about a product. Similar to the book module, the product module will allow members to identify through a search interface whether a node for the product already exists in the grouponomy. If it exists, a user interface element such as a hyperlink will be used to allow members to easily navigate to the related grouponomy node. This search interface may also be configured in future embodiments to allow searching of commercial data stores such as sites or web services to obtain product information. In cases where an organization is using an online store component provided as a part of Member Crossing, the products available for sale in the store will be available in the search results for linking.
It should be noted that in one embodiment of the solution the book module may be combined with the products module to create a single module for tracking any type of product. In this case, said combined module will track the product type in addition to all other necessary information related to the product.

Listing
Jobs—The jobs module will support aggregation and will function as a repository of jobs listed in the organization. In the first embodiment of this solution, the module will be designed for members to post job openings. In subsequent versions of Member Crossing, we envision the job module becoming a feature-rich job posting application to be used either within Member Crossing or as a standalone job board that can be integrated with an organizations main site.
The modules will support aggregation as stated above, meaning that jobs entered for child codes may be listed together with jobs from other sibling nodes in an aggregate view inside a parent node.
Job postings are an established way for associations to generate revenue, so the module will be designed with this in mind. The tool will be designed to support management through the administrative interface. Administrators may have the option to approve jobs before they are posted to a particular node in the grouponomy. Additionally, there may be an interface designed for organizationally based members to purchase different job posting plans. These plans will most likely be configurable by the administrator according to the options such as the following:
   Number of jobs in plan
   Price of plan
   Length of time job will be visible
   Whether the jobs can be posted without approval
An additional interface may be necessary for members who purchase the right to post jobs on the job board. This would function as a custom module as noted above. At a minimum, this interface could provide a listing of all the jobs posted along with the details of the plan that was purchased. Related to each job would be a listing of all the members who replied as candidates to the posting. Replies by members who are interested in the jobs may support the ability to link to their profile and upload one or more files such as a resume.
Classifieds—The classified module would support aggregation as discussed earlier. For the classified module, this would mean that members could post items in the classifieds related to a particular node. The classified module on a parent node would have the option, as has been previously described, to show the classifieds for the parent node or to show the classifieds for the parent node and for all of the children.
Vendors (community and paid listings)—The vendor module would support aggregation and would function as a way to associate companies with a particular node. The module would track the name and web site for each company and each vendor would be rated based on the standard Member Crossing module item rating interface (up/down rating). The process of adding a vendor would involve a search where the vendor name would be searched in one or more data stores to determine if the Vendor is already listed under a node in the grouponomy or if the vendor's information is available through a public data store or API.
In one possible embodiment of this solution, the vendor search screen would contain items such as a textbox in which to type the company name, a button or similar UI control to initiate the search, a UI region to show a visual rendering of URLs received from the search and a UI region used to show possible URLs when more than one URL is retrieved. The system could be designed to search public sites such as Wikipedia as well as the grouponomy to determine if an entry with the same name as the company already exists. The user interface will provide an easy to use mechanism to select a match and create an entry in the list of vendors.
Calendar—There may be two types of calendar modules or possibly one module which functions in two ways. First, calendar information may be stored in properties associated with class modules associated with child nodes under the currently selected node in the grouponomy. If this is the case, then the calendar node could show entries automatically on the calendar for any child node with data stored in the class module using the date time data type.
Additionally, the module will need to support the scenario where members need to track a variety of event related information for a particular node. The calendar module should be designed to support aggregation so that all events from all child nodes can be included in the parent node.
Initially, these calendar entries may lack any way to designate a category or a type, but future embodiments of this module may allow each calendar entry to be categorized and assigned a type. It may be important, for example, to be able to designate that a calendar entry is of type event, where event corresponds to an actual event requiring event registration. In this case, a URL may be associated with the calendar entry so that users may easily navigate from the calendar entry to the location for event registration.
Finally, because there may be functionality which transcends the features that will be listed in the Calendar slice for the grouponomy, there my additionally be a custom Calendar module used at the root of the site.
Related Nodes—There are at least three sections that will appear in this module. The first will show all other modules with the same name. The second will show all locations of modules when the module contains more than one parent. This is the case when multiple nodes are created using the linking feature (see the description of the 3 choices available to a member when adding a node with the same name as a node which already exists in the grouponomy). The third section will show nodes that other members have manually (or possibly automatically through the use of AI processes) associated with the currently selected node. These relationships may be shown at some place in the UI as links under a heading that could read, “See Also . . . ”
Store Items—For organizations that chose to implement the Member Crossing online store, store items will be associated with specific nodes in the grouponomy and the store items module will show these items inside the node.
Events & Sessions—The events and sessions module will be added to allow one of at least a couple of types of event related information to be associated with a node in the grouponomy: events managed through third-party tools and events managed by the Member Crossing event management module. The information tracked for events and made visible will include fields such as:
   Event Name
   Track Name
   Session Name
   Date(s) of Event
   Date, Time and (either Duration or ending time) of Session
   Speaker(s)
Events managed by the Member Crossing event management module may be associated with one or more specific nodes in the grouponomy to help provide context for the event or session. Additionally, nodes may be created in the grouponomy for an event, track or session. The event module will support both types of association with nodes in the grouponomy.
Tasks—The task modules will function as a way for members to assign tasks related to a particular topic. This module will be most helpful in the Project Workspace edition of Member Crossing. The tasks module will allow a task to be assigned to another member and will support group up/down rating so that tasks can be prioritized by group interest. The tasks module should support aggregation from child nodes and should support sorting based on both the created date as well as popularity as determined by the rating. The tasks module may support sliced viewing and may additionally support a filtered view where all tasks assigned to a member are visible in a list.
External Content Module—The external content module would be configured to search and list content available from third party stores of information such as Wikipedia, the MetaWeb or other similar sites. The data from these sites may need some kind of verification to ensure that the data is valid. This validation could be automated or could additionally take the form of member verification or staff verification.

Grouponomy Node Main View

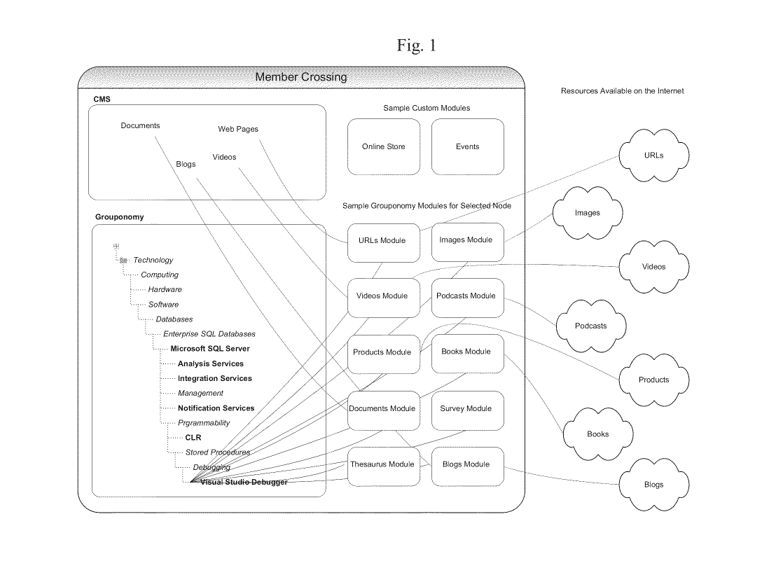

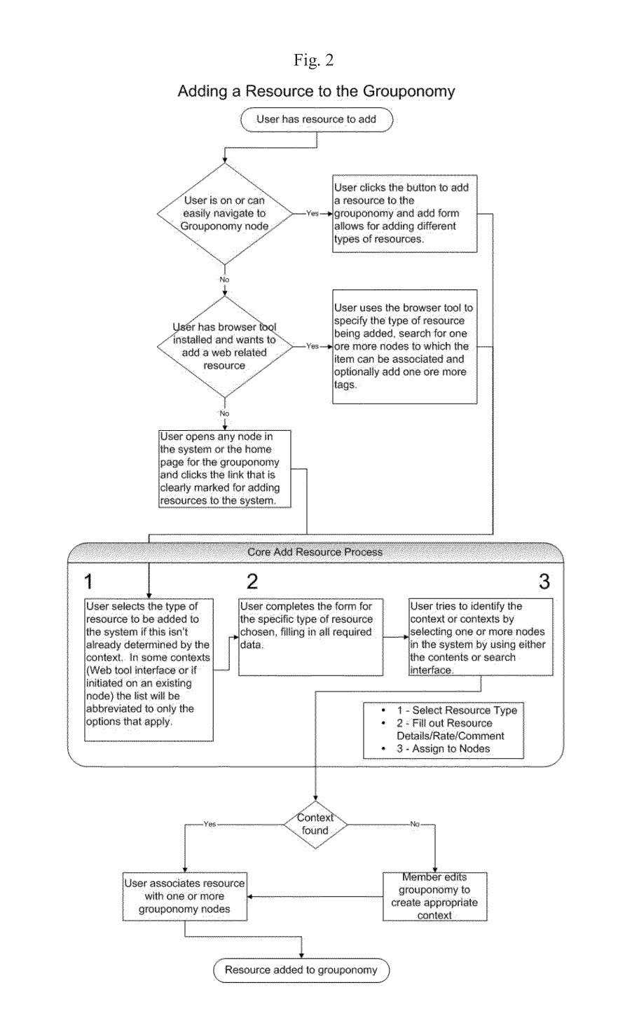

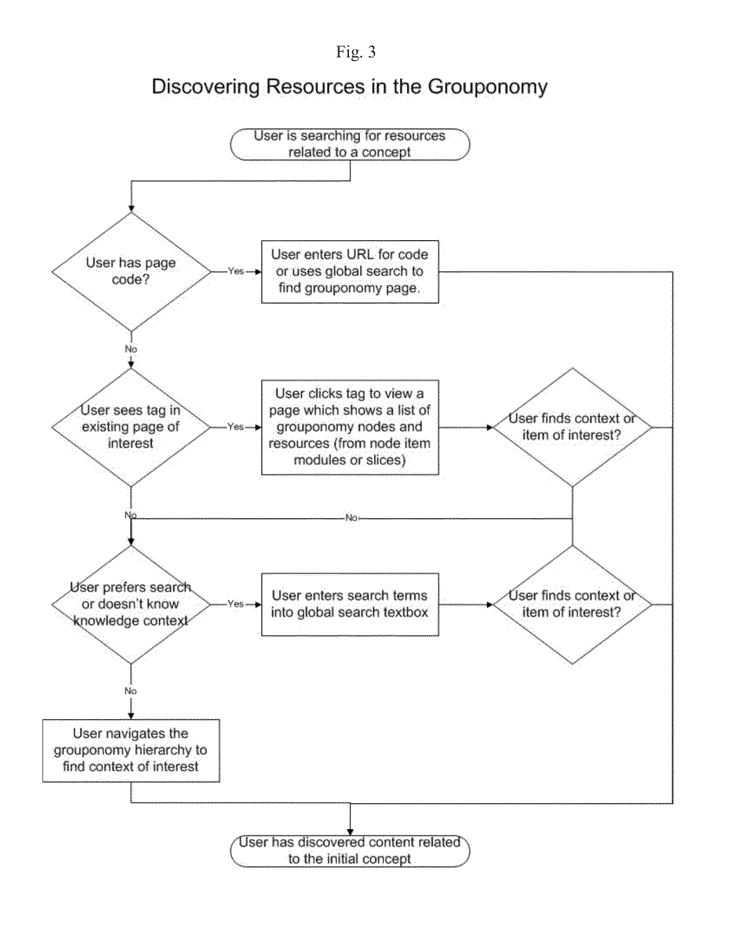

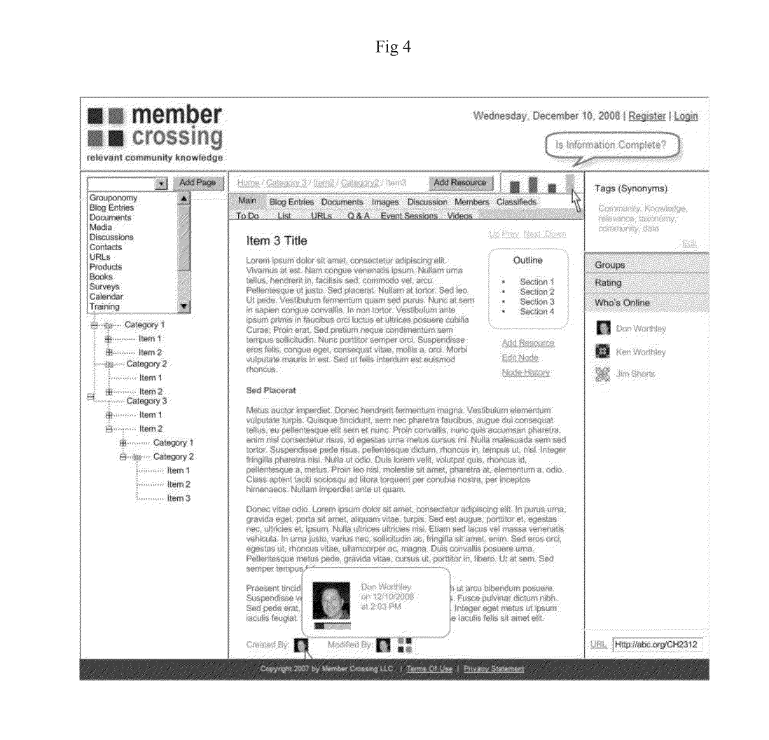

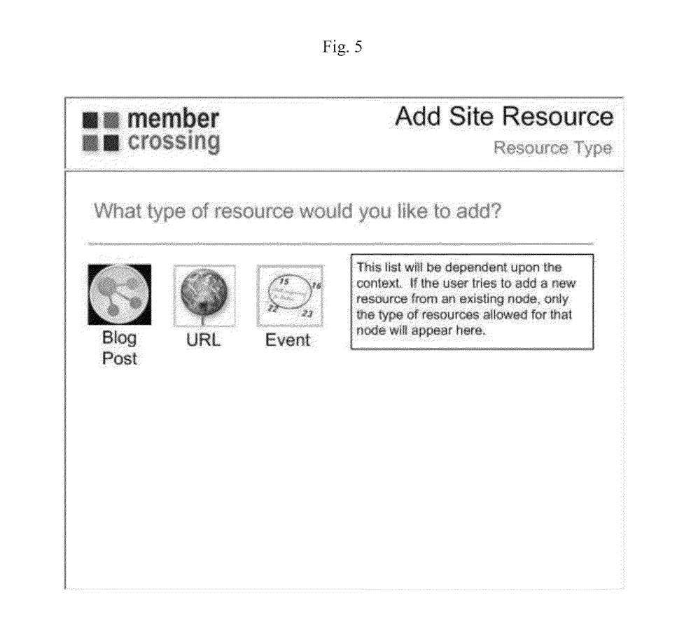

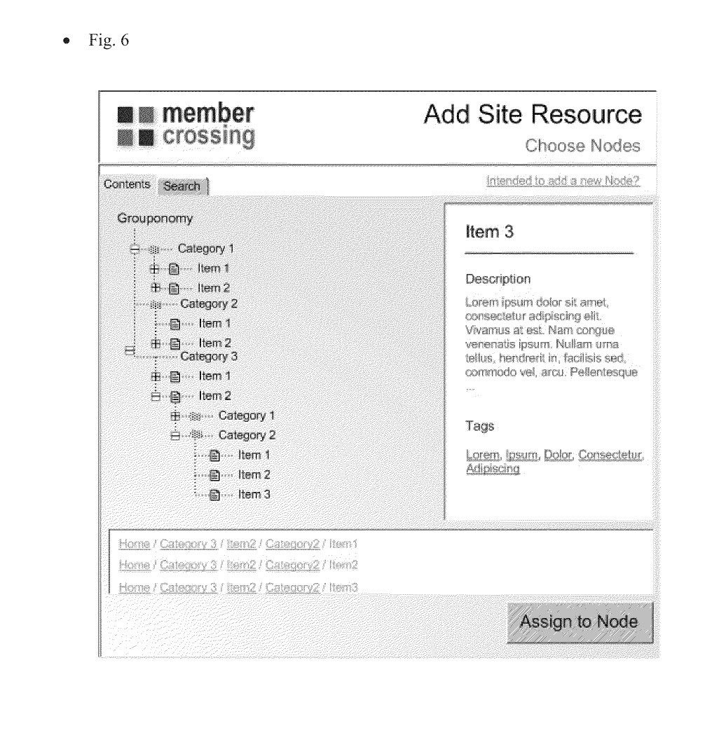

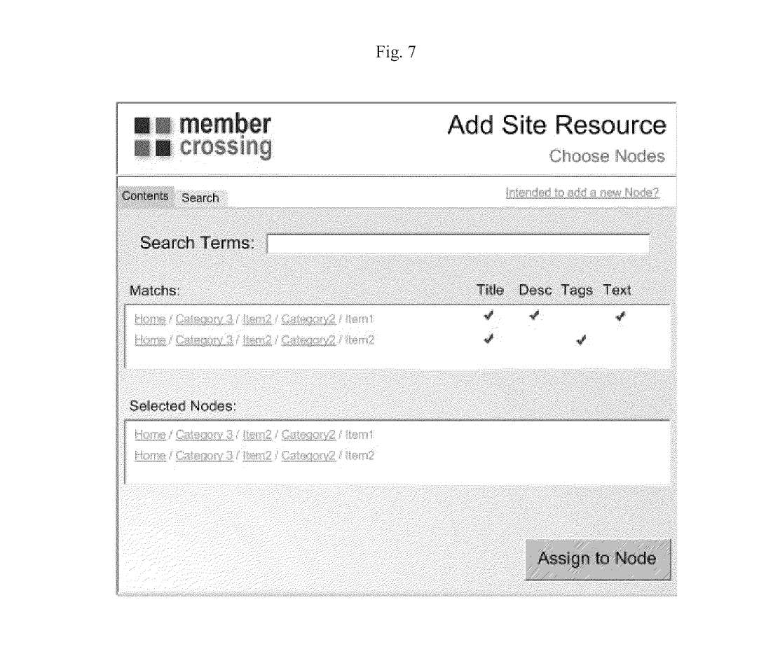

The default view of the grouponomy will be a view which shows the default text module for the node. In the first embodiment of Member Crossing, this view may look like the mockup shown in FIG. 4 below. In other embodiments of Member Crossing, the main content region may be enhanced to support showing an aggregate view of the text content entered in child nodes. The overall purpose of the grouponomy is also captured in Figure 1 in the Appendix. As the comments below this figure explain, this diagram shows the unique interrelationship between pages or nodes in the site and the content associated with those pages. Key aspects of the uniqueness of this solution include, but are not limited to:
Optional, easy management of nodes by members with custom business rules for managing who has access to manage the taxonomy
Contextualization of disparate types of information stored in a variety of modules which allows members to easily discover all knowledge artifacts related to a specific concept
Aggregation of module content making it easy to get a birds eye view of all of the resources associated with a particular node.

Grouponomy Slices

Most of the modules will support an aggregated view for the entire portal that for the purposes of this document will be called a slice. A module slice will be a view of the data for that module only based on the grouponomy. In one embodiment, this will involve showing the entire treeview representing all of the nodes in the grouponomy with the nodes that do not contain data related to the selected slice disabled. In other embodiments, nodes in the grouponomy which don't contain data related to a slice may not be visible. In another embodiment, the nodes are shown with in one of 3 visual states (states which could be presented using bold, italics and normal text, for example) to capture nodes which do not contain any information related to the current slice in the node or any of the child nodes, nodes which contain information related to the slice and nodes which contain information related to the slice, but only in one of the grandchildren nodes or deeper.

The main page for each slice will contain modules which show aggregated information to the user such as:
All items added by the currently logged on user.
Most active nodes for this slice
Most active users for this slice
Most popular items for this slice (used on slices for modules with items, such as products, discussion, etc).
Latest additions, etc.

In one embodiment of the solution, each member profile will contain an interface which shows all of the different slices of information added by the member to the grouponomy. This information could be made available for all members in the organization with the right permissions to see the profile. Optionally, each member could decide through configuration settings whether other users were able to see their contributions to various slices in the grouponomy.

Each slice may have an interface which shows aggregate information related to the slice. For example, the main interface for the blog slice could present the most popular blog entries for the current week as well as the most active grouponomy nodes for the same time period. Also of interest would be the most active contributors as well as the most recent contributions.

Grouponomy Node Export and Import

In one embodiment of Member Crossing, each grouponomy node will allow members with sufficient privileges to export the contents of the node into formats such as HTML, XML, PDF and Word document. Additionally, a feature could be added to allow members to easily email the node, and possibly all child nodes if desired by the user, to another colleague. This export process would be designed to allow the contents of a node and all child nodes to be exported. This feature will be useful in cases where the grouponomy is being used to manage hierarchical information that may eventually need to be aggregated into a document. This would be the case, for example, if the grouponomy is being used to store information related to a project. The user could use the export process to quickly create a hierarchical listing of project features and notes. In one embodiment of Member Crossing, plug-ins may be created for common productivity applications such as the Office suite of applications which allow members to easily associate various types of documents and email with one or more nodes in the grouponomy.

Grouponomy Node and Item Expiration and Relationships

In one embodiment of Member Crossing, both grouponomy nodes as well as items related to nodes will support content expiration. This will be a way for the community to note that the content is no longer useful and has been replaced by newer content. The node and/or individual items associated with the node will be left in a state that may have a visual aspect which will make it easy for members to identify that the content has been determined by members to be out of date.

Additionally, visual interfaces, such as timelines may be added to nodes as well as to some node items that will allow members to see the time range of usefulness for the particular node. This interface may be in the form of bars with dates showing the range of dates of applicability for the node or node item content.

Because many nodes and node items will be interconnected, it may be possible in one embodiment of Member Crossing for members to assign related nodes or nodes items at either the node or node item level. In the first embodiment of Member Crossing, this feature may be limited to nodes and the list of related items may be shown in a format as simple as follows:

Related Nodes: + Add New Related Content

First Related Node Title Here (CH2319)

Second Related Node Title Here (CH2342)

Of course, the language will be configurable and the format of the listings may change, but the idea will be to allow the community to extend relationships between nodes in the system.

Grouponomy and Blog Email Integration

Grouponomy nodes and blog entries may support publishing through email in future embodiments of Member Crossing. This may be achieved through distinct email aliases being created for members and for grouponomy nodes and may also be achieved through using one alias for all publishing and encoding either the subject or the text of the body with an identifier which would be used by the Member Crossing system to locate the right area to place the new content.

This would provide an easy way for content to be added asynchronously, thereby allowing members to work on their content through Outlook or a similar email client. This would also allow members to copy and paste images easily into their posts and the system could be designed to process the incoming messages, extract the mime content that contains the images and store the images in an images directory for reference in the blog or grouponomy entries that would be created.

Additionally, members may want to receive email notifications regarding new or updated content inside of Member Crossing. Each member may have the ability through their profile to subscribe to a digest version of changes made to Member Crossing. This digest version may be configurable so that members have the ability to subscribe to changes to zero or more nodes and all of their children, zero or more blogs, zero or more custom modules as well as any other areas or modules available inside Member Crossing which might provide an RSS feed showing new content. These digest emails may be sent on a daily, weekly or monthly basis, just to name a few of the options for intervals that may be implemented.

Finally, an overall design goal of Member Crossing email notifications will be that email notifications should support the ability for users to reply to the email alias. This will help to ease the transition for many who rely mainly on email for their knowledge management. To provide an example, let's say that someone clicks a checkbox in a node to subscribe to activity related to that node. This would result in the user receiving email notifications regarding activity for that node. Let's say that user receives an email noting that a comment has been added to the discussion related to that node. The user should be able to simply reply to that email to participate in that discussion. The reply should be automatically added to the discussion as a reply would normally be added through the web-based interface.

Individual Views of Grouponomy Data

Each grouponomy node as well as the slices may support a view of the data stored in the node and in specific slices that related only to the currently logged on user. This would help members to share the data with the entire group, but also maintain a feeling of personal ownership of data entered into Member Crossing. This view will help members quickly retrieve resources they may have associated with a node without having to wade through the hundreds of entries made by other members to the application.

One particular embodiment of this solution may be the ability for users to select one or more items related to a particular module as items of interest. These items of interest could be shown at the top of the list or highlighted in some other way so that the items are easily accessible to the user.

Offline Use of the Grouponomy

In one embodiment of Member Crossing, some subset of the grouponomy data may be made available to members for offline use. This application may run as either a standalone application, as a browser add-in or as an add-in to an email client or blog publishing software. These offline tools would make it possible for members to easily access the contents of the grouponomy while working offline. This will be important when the grouponomy and blog email integration features are introduced. It will need to be as easy as possible for members to locate nodes in the grouponomy for easy classification of the data available in the grouponomy. This may be achieved either through a stand-alone desktop application created specifically for use with Member Crossing or through the use of add-ins or plug-ins to existing office productivity applications or other such commonly used applications which provide for extension.

Grouponomy Portal

The community portal will be the entry point for the community. The initial view of the portal in the first embodiment may be a view of the grouponomy depicted as a treeview on either the left or right side of the user interface. A main part of the screen which is not used by the treeview may show an initial welcome view for new users. For returning users, the main part of the page may show the last viewed slice and node in that slice.

As described above, the user interface may be designed to allow users to view different slices of the grouponomy data in order to focus more narrowly on the kind of content in which the member is interested. In one embodiment of the solution, each slice may have its own separate interface which may show a restricted view of the grouponomy nodes showing, for example, all nodes related to the current slice enabled and all nodes which do not contain data related to the current slice as disabled.

Another possible embodiment being considered is to add functionality to the grouponomy so the user could have the ability to select the type of items they are interested in seeing. This selection could take the form of a series of checkboxes or a button bar (toolbar) that would run along the bottom of the user interface and provide a way to turn on and off the different slices of data they are interested in seeing. For example, in this embodiment, if the user was interested in only seeing discussions (forums) and blogs, the user would have the ability to enable something similar to a toolbar button for blogs and discussions leaving all other buttons for the other slices available in the system to be disabled or unchecked. As the member would move from one node to another in the grouponomy, only the blogs and discussion modules would be active and items in the graphical representation of the grouponomy, such as a treeview, would be differentiated in some manner, such as make some items bold and others italics, thereby providing a visual clue regarding which nodes contain either blog or discussion related information. Because in some cases a node may not have blogs or discussion related information, but the child may, it may be helpful to show 3 visual states: one for denoting that the node and its children do not contain slices of the selected types, one for denoting that slices are available, but at least one level below the child node being shown, and one for denoting child nodes that contain slices of the type for which the member is searching. This embodiment would most likely be used in addition to having specific, separate interfaces for each slice.

Another representation of the main grouponomy portal may always show a welcome screen which may contain aggregated information from the grouponomy. This main welcome page to the portal could be designed to show information that has been aggregated from the knowledge stored in the grouponomy. Interesting community data could be made available such as:
Most bookmarked people (last week)
Most bookmarked people ever
Most active nodes in the grouponomy
Most active members
Most trusted members

This data could be presented to the user to provide a dashboard of community knowledge. Over time, this dashboard could grow to serve as the front page for the community knowledge base, showing trends as they occur in the community in real time.

Related to the most active nodes, the presentation of the grouponomy nodes could be altered using styles in order to show the relative interest in each of the main nodes in the grouponomy. This could be done either using font or color or graphs shown off to the side of each of the main nodes. As each node is expanded, the same method of highlighting could be used to show the relative level of interest in each of the child nodes. This could provide members with a quick way to see which topics in the knowledge base have attracted the most interest over a certain period of time. This method used to show the most active methods could be configurable by administrators. Options could include, but may not be limited to:
N day moving average of posts to any of the modules
N day moving average of posts to one or more selected modules
Total number of posts to any of the modules over n number of days
Total number of posts to specific modules over n number of days

Additional Member Crossing Features

Custom Modules

Most of the modules listed above will be used in conjunction with grouponomy nodes; however there is a set of modules which we will call the community modules which may have modules which relate to grouponomy nodes, but will also have functionality which cannot be easily associated with a slice representing information stored in a hierarchy of grouponomy nodes. A good example of this would be an online store where products may be associated with Grouponomy nodes, but where the functionality related to the online store extends beyond the kind of aggregate data that will be displayed in the main page of a store items slice. An Online Store must allow for multiple views of the data, for a checkout process and for a shopping cart. Theses custom modules will be managed as CMS pages through the CMS page management features.

The following modules should not be considered a complete list of the modules that will be needed for the use of Member Crossing in specific industries or for specific types of communities; rather this list should represent a list just long enough to establish the kind of custom modules that will be developed for Member Crossing. Also, since the module API will be open and well documented for Member Crossing clients, each client will have the ability to create their own Member Crossing module.

In the preferred embodiment of Member Crossing, the custom modules will form the basis of the main set of pages for the site. The presentation of these main pages which contain the custom modules will be different depending on the client, but these modules will be listed along with content pages to form the main menu of choices within the site.

The following modules would be useful mainly when Member Crossing is used in CMS mode for a community portal
Real Estate Listings
Agent Listings
Business Directory
Member Directory
Vendor Directory
Event Management
Calendar of Events
Job Board
Virtual Exhibit Hall—a module for quickly viewing vendor information for the entire industry in one place. In the preferred embodiment of this module, the user could have more than one way to view the vendor listing. For example, members could choose between an tabular listing of vendors which could be sorted based on the company name, the ratings related to the company from grouponomy entries, the number of items to which the company is related in the grouponomy, etc., or a graphical or 3D representation of the vendors based on their relationship to the grouponomy.
Online Store—as mentioned in the example above, the online store could provide members with some of the standard online store features for use within their community.
Community Groups—Community groups could provide a listing of all the groups in an organization or just groups that are available for all members. For organizations with groups that have physical meetings, this would be the location for associating data with the group such as meeting times, location of meetings, requirements for membership and other information that may be stored in specific fields or stored in a free text field. In one embodiment of the solution, a grouponomy node may be created for each group to allow members to associate a variety of types of information with a group. In this case, the groups would be listed in the community groups module with links to the pages which contain the more detailed information about the groups.

An SDK will be created to allow for easy implementation of modules for other types of community portals, such as church portals or housing association portals. Examples of modules that may be created for community specific portals would be:
Prayer requests
Community Needs
Group Gatherings
Shared Items
Resource Management
Scheduling

In one embodiment of Member Crossing, the Online Store may be enhanced to allow members to register for an event. The Member Crossing grouponomy infrastructure may also be designed so that a special event module can be associated with nodes defined as event related nodes. This assignment could be achieved using the association of a particular type of class that would signify that all child nodes and any event related modules should be included in the registration process associated with the event. This would allow an event coordinator to combine descriptive elements about different aspects of the event along with an interface to sign up for that particular aspect of the event. These event related modules could then be presented in one aggregated registration interface which rolled up the different event elements that related to registration. For example, under an event, categories of type track could be created; and under these categories, pages could be created for each session. In each session page could be a description of the session along with an interface which could be designed to allow prospective event attendees to not only view ongoing discussions related to this particular session, but to sign up for the session while on the page. This information would be saved and available when the user was ready to complete the final event registration process.

This infrastructure would make it intuitive and easy for event coordinators to put together a site for an event that automatically contained all of the community integration and knowledge sharing features needed to augment the event both before and after the event. Before the event, prospective attendees could interact with people of similar interest and after the event, members could continue the conversation started at the event and keep track of key contacts they made while attending the event.

Drag and Drop Controls for Images and Files

One of the issues facing the use of Member Crossing to add information to blogs and to grouponomy nodes is the difficulty currently related to copying images or other files when editing online content or when trying to copy a group of files to the web server. Currently, images or other binary data that needs to be stored on the web server needs to be saved locally, uploaded to the web server and then formally placed into the HTML editor being used. There are a number of solutions to this problem that may be employed.

In one embodiment of the solution to this problem, a browser tool such as a browser add-in may be created to allow members to quickly drag and drop or paste images or other files that will be uploaded to the proper location for use in Member Crossing. In this case, Member Crossing may be designed to detect that a file has been uploaded and insert the file into the tool currently being used to add content or into an active grouponomy node in the case of files that are being uploaded. The end result will be that the member adding content will be able to either drag and drop or paste an image or other files from the clipboard and have that image or file or group of files be available for their use within their editing environment without having to save a file and explicitly choose to upload it to the web server. This browser control may take the form of a side-bar control which appears inside the browser window and allows the member to easily upload files as mentioned.

In another embodiment of the solution to this problem, the member will use a control that exists in the web page to add content. This control will be an embedded control which uses technology that enables files to be dropped or pasted directly into the control. As in the embodiment above, the control will take care of saving the image to the web server.

Additionally, a desktop application or an add-in to a tool such as Windows Live Writer may be created to use the MetaWeblog API to allow users to easily add content and have any binary content such as images automatically saved to the web server.

Module Features

A set of module features has been referenced, but not described up to this point. These features may include but may not be limited to:

Tagging
Rating
Group level security
Comments
Aggregation

Member Crossing modules may be designed so that the functionality needed for each of these features is centralized through the use of custom user controls as well as through the use of interfaces (programmatic interfaces) to defined functionality that should be associated with a module. In the preferred embodiment of Member Crossing, Rating may be shown for each of the module items as they are listed with tagging, comments and group level security accessed through clicking an interface item which allows the member to access these additional features. Aggregation may not be configured at the item level, so an interface element may be included to allow members to choose whether they want to see data aggregated for the current node as well as all child nodes. In the initial embodiment of Member Crossing, this may take the form of an interface element such as a simple checkbox; however, in other embodiments, this may be expanded to include a mechanism for members to select specific child nodes to aggregate. Additionally, and related to aggregation, it may be possible to define a plurality of aggregation categories so members could choose at a higher level which aggregation categories they wanted to view. These categories could be chosen from or actually defined by the properties that are tracked by any of the modules which support aggregation. An example of how this feature may be used is a feature tracking module for projects. Members could create a hierarchy of product features to be tracked in the grouponomy, but only a handful of those features may be assigned to a particular phase or a particular sprint. At a parent level, members would have the ability to quickly view only those features which have been assigned to a particular phase or sprint. These features could be presented inside of a hierarchical grid control to show the hierarchy that exists with the features to be listed and the hierarchy of child nodes to which each feature belongs.

Custom User Controls

A set of custom user controls will be created for Member Crossing staff to centralize functionality needed on many different pages. Examples of the user controls needed are:
Module Item Rating—The module item rating control will provide a simple up/down rating system where members will have the opportunity to vote only once by selecting the visual interface element for either the up vote or the down vote. In one embodiment of the solution, the up/down indicators will be represented by + and − symbols with a simple border around the symbol.
Modules that support module item rating should support a way to sort the items by at least 2 factors: item creation date and popularity, where popularity is determined by a custom algorithm which determines the popularity of the item over time. One such formula to be used would be a simple 50 day moving average where the numbers for each day would be calculated by simply adding the sum of all + and − votes where a + would constitute +1 and a − would constitute −1.
Module Item Comments—It will be common for some modules to require that each module item allow comments. This may be the case for modules such as the images and the multi-media. These comments may not be threaded and should be represented using HTML. Multiple controls may be needed to govern the following needs:
   Control to Show that Comments Can Be Added
   Control to Show existing Comments
   Control to Add a new Comment
   The item comments and item rating controls may be combined into one control to allow members to easily provide both rating and comments.
Access Control Dialog—Throughout Member Crossing there will be a need to manage the access control list for various elements such as pages, modules and module items. A generic access control dialog will be created to allow for quick and easy searches of the users and groups available in the current portal. The end result of this control will be a list of users and groups that should be allowed access to the resource in question.
One embodiment of this control will contain 2 main regions: one for a tabbed control and one for a list or text type control to show the selected users and groups. The tabbed control could contain tabs for users and groups where the group tab contained a graphical representation of the group types along with the groups in the system and the user control contained a search interface along with a control needed to show results of the search for selection. Selecting a user or group in either tab would cause the user or group to appear in the list of selected users and groups. Opening the dialog for a particular resource which already contained access control users or groups would cause the controls list or text region at the bottom to be pre-populated with users and groups. This interface for showing the assigned users and groups could have as a part of the interface a way to remove users or groups by selecting one or more of the users and groups and selecting a user interface element which caused the removal of these groups.
Because this control may be used by members to manage the access control lists for grouponomy nodes, the control should also provide a way to view the history of the access control settings. In one embodiment of this control, the history interface could be activated by a user interface control such as a button. The history interface should list the entire history of changes by date along with an option to view the history. The interface for the history screen could be presented as some type of list on top of another similar list control, the top list showing each change and the bottom list showing the access control list settings for the currently selected history entry. A user control could be made available for each history entry to allow members to revert to the previous values of the access control list for that control.
Grouponomy Node Selector—The grouponomy node selector will be used throughout Member Crossing wherever a member needs to quickly find a grouponomy node. One example where the use of this control will be important is in the browser toolbar interface used to associate resources with nodes in the grouponomy.
One embodiment of the grouponomy node selector could be an interface that contains a text area for the user to enter one or more search terms into. The user could trigger the search by using a combination of keys on the keyboard or by selecting a control such as a button. The grouponomy selector may also contain a region to show a listing of nodes in the tree which match the search terms entered. This listing may be divided based on matches from the name of the grouponomy nodes and matches based on synonyms associated with grouponomy nodes. A third section of this control could be included to allow the user to select one of the nodes shown in the list of matches and see the node in a graphical representation of the grouponomy. Finally, a section of the control implemented using a user interface element such as a list could be included at the bottom to show the one or more grouponomy nodes that have been selected. This grouponomy node selector could be designed to allow either only one grouponomy node selection or many, depending on the needs of the control in its context.
Tagging—many modules will be designed to support tagging of elements added to the grouponomy. This will provide a way for additional context to be assigned to resources added to a node and will give members a way to easily cross-reference resources from other nodes. Tagging data may be stored in one central location for grouponomy nodes as well as for tags related to module items. Data may be stored with each tag to note whether it is a tag assigned to a grouponomy node or whether it is a tag assigned to a module item. For tags assigned to a module item, data will be stored to associate it with the correct instance of the module (data such as tabid, moduleid, etc.). Tagging data may also be stored separately for synonyms related to grouponomy nodes and for module item tags.
Geographical view of member lists—throughout Member Crossing, there will be features which make use of lists of members. Groups will be made up of lists of users, lists of users will be returned from queries to see who is associated with a node and all of its children, and groups of members may be returned from custom queries of profile data. Throughout Member Crossing, where lists of users are available, such as with all of the members who have associated themselves as contacts related to a node, a custom user control may be made available to show a representation of the location of each of these users on a map. This user control would only be visible in system where geographical data is stored related to member's profiles.

Member Profile Pages

Each member may also have a profile page that they can fill out with information that may be of interest to other members within their organization. Members may have the opportunity to manage varying levels of contacts in subsequent phases of the product. The first phase of the product may allow members to quickly see data related to other members who have participated in sharing data using one of the Member Crossing community tools.

Each member profile page will consist of one or more pages containing modules designed to show as much or as little information as is required by the organization and or is desired by the member who owns the profile page. Since one of the main goals of Member Crossing is to create communities that can build useful, shared stores of knowledge, one of the mail modules available to the member portal will be what we will call for this document the contributions module. The contributions module will visually present the contributions made by the member. One of the most common forms of contribution to the community will be through the member blog, so the member's blog entries will be easily accessible from within the contributions module.

Additionally, and this may be something that can be customized for each organization and also possibly by each member, the member's community contributions may be made available in a public manner. In the embodiment of the solution that supports this feature, the member's portal will be accessible without requiring authentication. In other embodiments of this same feature, the member portals may be accessible, but only certain modules or certain items within the modules made public. These will be settings available from within the administrative interface as well as from within the interface used by the member to manage their portal.

When logged in to their own portal, members will have the ability to edit the modules that appear in their portal page(s). Examples of the kind of modules that we envision for the member portals are as follows:

Relationship Tracking
This module may be designed to allow members to quickly create a list of contacts according to the rules defined in the XFN specification as well as a few possible custom rules. Relationship links may be one way, and if so, will be recognized differently when two one-way relationships are added to the system. For example, if I note that Markus Pope is my friend, but Markus notes that he is an acquaintance, then the relationship listed from my profile will show up as a friend with an additional visual indication that Markus' has also entered a relationship set to a level of acquaintance.
When viewing other people's profiles in the system, the relationship tracking module may be designed to show a list of the people we may both know in common based on the relationship links stored in the system.
This data may be shown through text or through graphical representation.
This module may provide an interface for showing mutual friends. This mutual friend module may also function as a standalone profile module. The purpose of this module will be to show how a member is associated with the member who's profile they are viewing. In addition to showing relationship available through the relationship links described above, relationships may also be shown based on past data from the grouponomy, from group membership or from any of the custom modules. For example, if you are viewing a member's profile and you are both members of the same group, this could be noted in the interface. If additionally, you both attended the same sessions at the last 3 conferences, this information could be shown to make it clear how you may have had contact with this member before. Furthermore, information could be shown related to involvement in and related to blogs or grouponomy nodes such as, but not limited to:
   Viewing all members who have directly responded to blog entries through comments
   Viewing all members who have directly responded to comments made in one or more nodes, where the nodes could be selected as noted below.
   Viewing all members who have contributed in any way to selected nodes.
   Viewing all members who are listed along with you on n nodes as contacts related to that particular node.
For relationships related to nodes, the interface could allow members to specify one or more grouponomy nodes to use for listing related people.

Coaching or Mentoring
This module may be designed to facilitate coaching and or mentoring relationships that may exist within an organization or within groups within that organization. This module may be designed to allow for an extensible infrastructure which may support tracking a member's progress through a series of measures of achievement possibly organized into categories, by grouponomy node or nodes, by group within the organization,
One possible embodiment for this solution is a framework for organizing and tracking data structures that function as rubrics to keep track of a member's progress as they collaborate with zero or more mentors. These rubrics could support categorization and assignment to zero or more grouponomy nodes. The categorization could be designed to support a plurality of levels of hierarchical organization and measurement of the success of each unit of measurement in a rubric for 1 or more members or groups. These rubrics would comprise a plurality of units of measurement that would allow both mentors and those being mentored (either members or groups) to track the progress of the unit of measurement as well as the aggregate progress of a plurality of hierarchical levels of unit of measurement categorization. Each rubric may support a plurality of levels of categorization for the individual units of measurement so that in cases where a rubric contains a large number of units of measurement, they may be organized into a plurality of categories that may or may not be organized hierarchically.
Units of measurement may support tracking progress through the same infrastructure used to manage responses to survey questions. As such, the infrastructure may support a variety of response formats such as:
   Multiple choice
   Free-form response
   Rated responses supporting n levels of rating
   Choose n of m multiple choice answers
   Choose all that apply
   Boolean responses
This list is not exhaustive but serves to represent the fact that user progress will be tracked using the same kind of infrastructure used to track survey questions.

Contributions
The contributions modules will be designed to show the contributions of a user according to a variety of views. The default view will most likely be to see the latest blog entries for a member, but this view will be configured to also show contributions made to any of the specific slices of content available through Member Crossing as well as in an aggregated form showing content added. In each of the views, it may also be possible to sort the content by popularity based on the average number of hits over a given period of time.
The main two types of contributions that will be available in the first embodiments of Member Crossing may be Blog entries and URLs. Entries for all of the other slices of information associated with grouponomy nodes may be available as these features are added to Member Crossing.

Currently Reading
The currently reading module will be customizable by each member to show a list of the books they are currently reading. The same interface used to add books to either the book module or to the product module will be used to add books to the currently reading list.

Books I've Read
This module will keep a list of the books read by the member along with a short review in HTML that can be shared with other members. In one possible embodiment of Member Crossing, the book related information will be stored centrally so that books which are added to the following modules will be stored in one central location: currently reading, books I've read, books module related to grouponomy nodes. In this embodiment, if the system recognizes a book node, the system may be designed to reference the book data that already exists in the system. This would make it possible to create a custom book review module for book nodes which would aggregate all the book reviews made by members into one location and allow other members to rate the book reviews.

External Social Networking Data Module
A series of modules may be created to show data from external social networking sites such as Delicious. This will allow members to maintain some of their investment in these tools. One solution that will be investigated is writing a tool to allow members to migrate bookmarks from bookmarking services such as delicious or Google.

Free Text Module
This module will be available to allow members to add whatever free text they would like to their profile. Multiple instances of the free text module may be allowed on the profile page.

Education Module
The education module would allow members to manage a list of the educational institutions they've attended and the degrees they've received. A central list of educational institutions would need to be maintained in order to allow for data mining at a later date. However, the first embodiment of the solution could be created by storing the educational institutions and the degrees as just text. This could be converted later.

Work History Module
The work history module would show a list of the previous employers along with dates of employment. Similar to the education module, this information could be stored as text and in later embodiments of the solution stored in a centralized employer data structure.

Things Flagged for a Member

Things Flagged by Others
Things flagged for me idea. In one embodiment of this module, there may exist an interface for the member which functions like their email inbox where multiple types of action items can be stored. These action items could be presented in a way which allows the member to easily mark off items as completed or in progress. Interfaces would be needed in any part of the Member Crossing solution which allowed content to be added to Member Crossing system. An additional interface could be added to allow members to not only assign the resource to one or more grouponomy nodes, but to also assign the resource to a member or a group of members to be included in their flagged items module. As resources are flagged for other members or groups, users may have the ability to assign different reasons for assigning the resource. Reasons may include:
   To Read
   To Respond to
   To File in Grouponomy (sent to an expert in a particular area)
The idea here is to get work out of the email inbox and into either the grouponomy or grouponomy workspaces and often email messages are sent to other people just to make them aware of a resource available on the web.
Members could choose to be updated via email regarding new entries to their things flagged module either on a predefined basis, such as daily, weekly or monthly, or on a custom basis, such as every hour or when messages arrive. In other embodiments, members could be sent an IM, an SMS message or a message for some similar platform.

Things Flagged for Self
Occasionally, members may desire to file resources without taking the time to relate the resource to one or more grouponomy nodes. This should be achieved as noted above through an extension to the interfaces used within Member Crossing to add content to the system. Any of the interfaces used to add content into Member Crossing may support a feature where content can be added without association to a grouponomy node. This could place the content into a special unfiled section for each member that could be accessible through their profile page. This section would allow members to manage their unfiled content. The system could be configured to automatically flag content added to the unfiled section which is filed by other members of the community. The interface for viewing the unfiled resources could be configured to show resources filed by other users in a different view or through a sorting mechanism where the resources that have been filed are easily separated from the resources that no other users have yet associated with a grouponomy. Users may then have the opportunity for each of these resources to add the resource to the same location or find another location for the resource.
The purpose of this feature will be to make it as easy as possible to add content into the system. In many cases, members may want to add content to the system for later follow-up.

Member Affirmations

Members may have the ability to provide affirmations related to other members in their network. These affirmations may be related to member trust level as defined elsewhere. A member's profile may list the number of affirmations received along with a way to view the full list of affirmations showing the affirmations along with the members who provided the affirmation and whether the affirmation was related to an entity in Member Crossing, such as a grouponomy node.

Member Trust

At the core inside an association is the level of trust that is developed between the members of the organization. As members add content into the Member Crossing system, they will become identified in the community as trustees of the knowledge available in the community. Members who are active in a variety of areas in the grouponomy will have a higher trust rating. There may also be levels of trust that are assigned to specific nodes in the system. Trust level may be calculated based on a variety of methods. Here are a few that may be used:
Trust is calculated based on the total number of + and − votes received related to content added to the system. If, for example, a member has added two URLs to the grouponomy, and one received five + (plus) votes and one − (minus) vote with the other receiving four + votes and two − votes, the total trust level for this member would be 6.
Trust is calculated on the average number of + and − votes received related to content added to the system. If, for example, a member has added two URLs to the grouponomy, and one received five + (plus) votes and one − (minus) vote with the other receiving four + votes and two − votes, the total trust level for this member would be 3.
Trust is calculated based on a moving average of the amount of trust accrued per time period, where time period could be configurable based on number of days. The length of the moving average could be configurable as well. This would allow administrators to create a 20 unit moving average where the unit is 7 days. This would result in a 20 week moving average of average weekly trust points.
Trust is calculated based on configurable business rules for each organization that determine the points applied to each member. Trust related points may be assigned based on any of the activities tracked by the system

Member Crossing may be designed to use and show more than one method of determining member trust. For example, members may be shown the total amount of trust assigned as well as the trust average. Additionally, an effort may be made to show more than one trust value. For example, the main ranking of users may be based on a week's worth of trust related data, and another view may be determined by all of the data in the system.

In order to facilitate the collection of member trust related to resources added to the system, a method of collecting that trust for resources will be employed. This method will involve showing resources using a visual interface which allow a member to view the resource, rate the resource without leaving the interface and easily move backward and forward through other similar resources. For example, let's say a member wants to view the URLs associated with a node. The member would select a URL which would cause the resource to load inside an interface which would contain a set of controls for rating the selected URL or for moving either forward or backward through the other URLs in the list. This will make it easy for members to review the resources. An interface element may also be included to allow a member to open the resource in a separate window.

Member Crossing may also have an infrastructure which tracks all the events in the system which may be related to trust. This tracking infrastructure may be designed to allow each portal to manage different trust related business rules independently. Each portal may manage trust related business rules within one or more objects which may be designed to listen to events as they arise. Additionally, the system may also be designed to maintain a log of trust related events which are recorded in a database table for future data mining purposes.

Member Comments

In one embodiment of this module, members will have the ability to add content to another person's profile. Each member could have access to the contents added to their comment section so that comments could be deleted if needed. Members may also have the ability to respond to the comments added to the comments section.

This comments module may take different names, and in fact this module as well as all of the other member profile modules may support custom naming either by the member or by the administrators for the organization.

In one embodiment of this module, comments may be added through a visual metaphor which could appear to other members as sticky notes on a poster board, white board, door or wall. These sticky notes may support dragging and dropping into any section of the UI which allows notes to be placed. Additionally members may have the ability to use their pointing device to “write” on the member's comments module. With this feature enabled, members could have the option of erasing the drawings added to the surface, possibly all at once or one by one.

Member Status

Because members may have the ability to see the online status of other members in the system, members may want to have the ability to change their status while working in the system. For example, members may want the ability to assign a freeform status to be shown to other users of the system. In one embodiment of this module, the initial options for this module may include:
Show online status to:
   Anyone marked to a specific contact relationship (show drop down with XFN entries listed according to level of relationship) or higher
   Everyone
   Only specified members or members in specified groups
Do not show online status

Additionally, the interface may allow members to show a message related to their current status. This message could be freeform and could be visible to anyone in the system.

The Game of Tag

As is common among those who blog, there may be interest in an organization on the part of some of the members to start a viral survey or poll which they send initially out to a few people they know with the expectation that the survey is sent out to others in the community. The ability to participate in a game of tag could be limited to those with a certain trust level within the community. This would help to encourage engagement and participation among members.

The tag game module may support multiple types of tag. One type of tag that has already been mentioned would involve members responding to a survey or a poll created by the originator of the game. Another game of tag that could be initiated just for fun in the organization would be a game where members are ‘tagged’ and the only thing that happens is that an image appears in their profile (possibly defined by the administrators or to the member starting the game) which would stay in the profile until the member tagged another member. In this version of the game, only one person could be tagged at a time and the currently tagged member could not tag the person that just tagged them.

An additional element that may be added to the Game of Tag would be an external interface for community games which would show the current state of the game as well as the past state of the game. This would be a fun way to see visually how the games evolved. Graphical representation of the game of tag could be made using a tree view or an actual two dimensional representation of a graph which showed where the game originated and links to each member who was tagged. Members could drill down on each of the members to see how they responded. An additional interface for the game of tag could be an aggregate view of the results of surveys which had responses that would lend themselves to a representation of the survey data, either graphical or otherwise. For freeform textual responses, the responses could be listed in order of response.

Who Viewed My Profile

If permitted by a portal administrator, it may be possible for members to view a module on their profile which would show who visited their profile and what the origin was for the visit. Members may have the ability to see how other members were directed to their profile. Was it from a specific node or was it from someone else's profile, or was it from a direct search? Related to this, it could be possible for a member to see which of their friends sends most of their profile visitors their way. This could be shown through graphs, Tag-like bolding of member's profile names, etc.

Grouponomy Node Bookmarks

Each member may have the ability to maintain a list of grouponomy node bookmarks for easy reference. This module may be configurable by the member to be visible to only the owner or to groups of members in the community defined by either zero or more groups, zero or more members or members who are related to grouponomy nodes. These grouponomy bookmarks may additionally be accessible to the member through the interfaces created for adding content from third party tools. For example, these bookmarks may be incorporated into the browser toolbar in such as way as to make it as easy as possible for members to associate resources to frequently accessed nodes.

Member Profile Wizard

Member Crossing will be designed to allow for custom registration processes for members who come to the site for the first time. The end result of the registration process will be a completed Member Crossing profile with at least the required fields (as defined by the organization's administrator) filled in. This process may be different for organizations that choose to integrate their membership information with Member Crossing. For organizations that chose to integrate their membership data with their back-end management systems (their AMS or equivalent management system), there may be two or more levels of membership integration:
Basic membership integration—this is the authentication information used by the member for access to their existing member's only content.
Member profile integration—integration with the organization's management system (their AMS or equivalent management system)

The various forms of integration have been described earlier.

The basic registration process will consist of 3 parts:
Welcome message along with basic authentication information such as:
   UserName
   Password
   Display Name
   Email Address
   First Name
   Last Name
Introductory profile information which is customizable by the administrator
Getting Started Page which may contain a video along with other educational resources to help the member engage in the community as soon as possible.

One goal of these pages is to find creative ways for members to engage in the community. In order to maximize the level of engagement, we realize that the features of the application will need to be designed to appeal to multiple personality types that exist within an organization. Personality types can be divided into the four main types defined by Hippocrates: Sanguine, Choleric, Melancholic, and Phlegmatic. Each personality type may be encouraged to engage in the community by highlighting aspects of the application which may be of more interest to some of that specific personality type.
Choleric—show points, hook with competitive aspect of tools
Melancholic—show statistics of some kind
Sanguine—show social networking capabilities
Phlegmatic—emphasize that it's safe and that it's non-threatening.

Each emphasis may be presented in the profile page as well as the getting started page where information about the profile can be gathered, statistics shown (melancholic), social networking aspects of the system advertised (sanguine), points shown (choleric) and the safe and non-threatening nature of the community emphasized (phlegmatic). These are just examples of one way the features of Member Crossing can be advertised to members as they sign up and should be considered representative of the unique process by which the system will be designed to raise the level of engagement on the part of members from all personality types.

Increasing Levels of Engagement

In addition to the design of the profile wizard, Member Crossing will be designed with features that exist to facilitate member engagement. The goal is to make it as easy and as attractive as possible for members to engage, both socially and through shared knowledge.

In one embodiment of Member Crossing, multiple levels of involvement will be designed as a part of the community to create an environment that feels like a game where there are levels and features that are only available to people who have reached a certain level in the application. There may be virtual locations within Member Crossing where people at only a certain level are able to use features reserved for this level or higher. There may be a virtual store with digital items or actual items from the bookstore which are made available as a way to say thanks to participating members. Additionally, there may be icons that are automatically associated with accounts that reach certain levels of achievement. These could be Gold stars, gold, silver, bronze and platinum medals, etc.

Some associations will already have natural levels of membership defined and tracked in an Association Management System (AMS) or some similar type of system designed to track member data. Member Crossing may be designed to recognize different levels of membership in the system by assigning members to groups that would otherwise require significant community involvement before being able to access these groups. This will serve to provide an immediate reward for members of an organization who have already taken the time in their organization to show through different levels of certification their value as a trustee of knowledge in their industry.

In one embodiment of Member Crossing, the system may be designed to allow the members of the community who hold a particular credential to assign a value in terms of trust points to their certification. This may be crowd sourced to all members with this certification by allowing members who hold the certification to each vote regarding the trust level that should be assigned to their credential. In this case, the actual trust value assigned for that certification is determined in real time by the emergent behavior of the group.

Member Profile Widgets

Member profile widgets may be designed for use by members in their third party blogs. These widgets may be useful to organizations to help people engage and to encourage membership in the organization. In one embodiment, the widget is designed to show one of two views: a view for other members of the organization and a view for non-members. Members and non-members could be determined based on the presence of a cookie from the Member Crossing site. For non-members, organizations could have the ability to brand the initial view of the widget and advertise the benefits of being a member. Additionally, any publically accessible information could be made available in this view. For members, the initial widget view would be designed to show items of interest to other members of the organization that would help them engage in the community. For example, the widget could be designed to show how the member viewing the widget is related through the network of connections made in Member Crossing to the member who has listed their widget. The view could also show recently added items, such as blog or discussion entries.

Additionally, widgets may be created to allow members quick access to certain functionality from Member Crossing, such as creating blog entries, viewing aggregate information from Member Crossing and showing alerts and messages that appear based on activity inside the Member Crossing community.

Another form of widget may be social networking applications designed to operate within environments such as OpenSocial enabled applications or within Facebook or MySpace. These widgets will have the advantage of the functionality available from within the social networking application, such as access to friend lists by members. Members may have the ability using widgets that run inside sites such as Facebook to easily invite their friends to participate in their Member Crossing community. Members may also have the ability to choose certain actions from within the Member Crossing community that are published back to their wall within their social networking application.

Member Profile IM Integration

Member Crossing profiles may support integration with Instant Messaging (IM) platforms in such a way that it is possible to see a member's online status from within Member Crossing. It may be additionally possible for members to use the Member Crossing chat feature to chat with members who are using third party IM applications.

Member Contribution Export

In one embodiment of Member Crossing members may have the ability to either export a set of their individual contributions or have continued access to their contributions to the system through their Member Crossing account which wouldn't expire. This could provide members with the security that the data they collect over time will be available to them even after they leave their organization. Since Member Crossing may be used as a way to organize valuable data, such as URLs, reminders to oneself of valuable resources, etc., this ability to access personal data may be extremely important to organizations considering the user of a tool like Member Crossing. This may require that all resources added to the system be tracked in one resource table or that there is at least a table or similar data structure used to keep track of all resources added to the system which may need to be exported.

Integration with Management Systems

Authentication
Authentication will be handled one of two ways depending on whether the management system contains hashed passwords.
Hashed password systems will require the development of a custom authentication provider. Member Crossing uses a provider pattern for authentication, so a custom Membership provider would need to be created for the client's management system. Custom membership providers will require a separate instance of Member Crossing.
Data related to authentication may be secured as it is passed over the Internet using SSL or other forms of encryption.
Asymmetrically encrypted passwords or plain text passwords can be updated directly in the underlying Member Crossing tables. In some cases it will be preferable to create a custom membership provider to handle authentication, in other cases it will work better just to write a custom script or use custom workflow to keep the passwords in sync between the two systems.
Bi-directional changes to passwords will be available to clients through an RFP and custom development.

Authorization
Authorization is handled through roles that are defined based on a custom role provider. Two scenarios will be supported related to roles for a particular organization: custom role providers and role imports.
Custom role providers will only be available in separate instances of Member Crossing since a role provider can only be set at the portal level.
All hosted versions of Member Crossing will provide a role import feature which will allow an administrator to quickly import roles from an external system.

Profiles
Profiles are handled by Member Crossing through a provider model; however, clients will be encouraged to use an interface to be developed for Member Crossing which will allow profile information to flow into Member Crossing.
Bi-directional profile updates will be available to clients who wish to allow their members to update their profile information from within Member Crossing. This will require an RFP and custom programming.

Single Sign-On
Member Crossing authentication controls will be designed to support single sign-on through redirects as well as through the use of web services. Depending how custom the single sign-on requirements are, there may need to be an RFP for custom consulting related to single sign-on. Other forms of authentication that may be supported are Windows Live and OpenID authentication.

Group Level Security

Groups can be created and managed by anyone in the community.

Groups to which a member has not been invited will not be visible to that member.

Group types will be used to create lists of groups, but the group types cannot be used in an access control list.

All nodes in the grouponomy will support group level security through an access control list. In the first phase of Member Crossing, users will not have the ability to exclude members based on groups.

Because group membership will be central to Member Crossing, there may be a hierarchical set of pages or nodes in Member Crossing which show information related to each of the groups. Members may have the ability to view any of the groups to which they below or to which they could belong (invitation is open to any member any they meet the criteria related to the group). These pages or nodes may have sections to show the current members, sections to show the requirements for membership in the group, whether the group is open and what specific requirements need to be met before membership in the group may be granted and sections to show group statistics based on an aggregate presentation of data available through the member profiles of each member of the group. The group statistics could show, for example, the total number of members in the group who hold a specific credential. These statistics may be configured by a portal administrator as well as the owner of the group. Group owners may be determined based on who created the group as well as assignment to this position related to a group.

An additional section that may be included related to groups is an event module designed to show events related specifically to the group. In the embodiment of the solution where an event module is available for each group, any site wide event modules may be designed so that events can be filtered based on their association with grouponomy nodes as well as their association with specific groups. This could give members the ability when using a custom event module for the entire community to filter the events and view only events assigned to specific groups. Another additional section that could be included in group pages or nodes would be a listing of vendor sponsored advertisements or promotions. This would allow organizations to generated revenue from ads that were targeted to a specific group within the organization's community.

An additional section could be available in the group page or node which would show the most active nodes for this group as well as the most active members based on a variety of criteria, such as, but not limited to: blogging activity, contributions to grouponomy nodes, comments, trust points, etc.

Each page or node representing a group may also have a section which may allow a hierarchy of sub-groups to be created for the management of groups within groups.

In one embodiment of Member Crossing, groups may support having members which are both members and groups. In this embodiment, the section showing the hierarchy of sub-groups will show all child groups which appear under the current group. In the initial embodiment of Member Crossing, groups may not support the ability to have sub-groups and when this is the case, the section showing sub-groups will be a listing for information purposes only, the hierarchy of the relationship of members in the group. In this case, the sub-groups may not function as valid security groups in access control lists.

Administrative Interface

An initial set of administrative accounts will be created for a client. These accounts will usually be used by staff of the organization. These accounts will be a part of a special group called administrators.

Member Crossing administrators will use the administrative interface for all administrative responsibilities including:
Managing groups—This module in the administrative interface could present the groups organized by group types to the administrator for access to an administrative interface designed to allow administrators to manage the members of each group. Administrators may have access to see all groups in the system, including groups that may have been organized by members and created as exclusive, invitation only groups. Administrators may also have the ability to manage metadata for each group including but not limited to: whether the group is open or by invitation only, what the specific requirements are for membership in groups that are not open. In addition to these administrative features, administrators may also have the ability to see all of the data included in the view of the group available to the general members of the group.
Sending e-marketing messages to members (Future phase)
Managing alerts—alerts may be real time alerts through various add-ins such as browser toolbars, desktop bands, widgets, plug-ins and other such applications which provide access to Member Crossing data or may also be alerts that are delivered to members through a module in their profile which shows messages.
Managing community surveys—portal administrators may have an interface which would allow them to assign a survey to everyone in the association, everyone connected with a node (at varying levels as described elsewhere), everyone in a group, and to a plurality of specific people. When a survey is sent out, it could appear through the alert system and additionally through the message system.
Managing uploaded files
Managing and installing modules
Managing store products (Future phase)
Managing events (Future phase)
Managing the types of nodes available
Managing the classes available through the class module
Configuring the visibility of things such as:
   The member profiles
   Specific modules on member profiles
   Edit screens that allow members to manage classes for the class module.
   Edit screens for the grouponomy. It may be possible for administrators to lock down the edit capabilities of either all grouponomy nodes or a particular node and or family of nodes starting with a particular parent node.

Additionally, page, module and item level permissions will be available to administrators throughout the site. This means that when administrators log into the site and they navigate to a particular page, the controls will be available to allow the administrator to edit content. These administrative accounts will have complete control over every aspect of the system.

Role imports will be performed through the administrative interface. In one embodiment, this will be accomplished in two steps: loading the list of groups from the external system (external group ID, and group name) and then loading a list of members and roles from an external system into the administrative interface in a pre-defined format. Some of the fields needed in an import would be:
Custom member ID from external system to identify the member
Custom group ID from external system to identify the group

Member Crossing would process the files, create all of the necessary groups and members and associate the members with the right groups.

Community Alerts

Member Crossing may be configured so that alerts of various types (real-time and asynchronous) may be associated with members in a variety of ways, including but not limited to:
members related to a node or any of its children based on various levels of relationship described elsewhere.
members associated with one or more groups
one or more individual members

This feature could be available to association administrators, but could also be available to anyone associated with a group. Messages from other members could appear in a message feed available to each member through their profile. These messages may be included in a member's list of messages in such a way that they are only visible to other members on the original recipient list. So, for example, if Sarah adds a prayer request to go out to her small group, other members from other small groups wouldn't see this on any of the member's feeds who are a part of Sarah's group. Only members of Sarah's small group would see this message.

The system may be configurable so that members do not have the option to message entire groups within the system, but only message individual members.

Trackback Infrastructure

Each node may be accessible through a special trackback URL which will be used internally and by third party blog applications to link back to a particular topic in the taxonomy.

The trackback URL may include the unique ID of the node along with an optional identifier to specify what type of resource is being identified with the node.

Other resources can be posted to a node using the browser toolbar interface and the type of resource being saved to Member Crossing will be identified by data stored in the trackback URL. In one possible embodiment of this solution, the type of data being stored (which determines which slice of modules to associate the data with) will be determined by a query string parameter. For example, the following URL would store a reference to a document stored on the local network available to all members:

http://community.xyz.org/trackbacks/id/CH238D7/type/document/URL/\\\file:\\p:roster.doc The ability to turn trackbacks on or off for a particular node may be accessible only to the administrators.

Browser Toolbar

An important feature of Member Crossing which will help to provide an extension of the organization that reaches out to the members on a daily basis will be a browser extension that is created for both IE and Firefox. This browser extension will have a dual purpose: to make it as easy as possible to add content to the grouponomy and to provide a mechanism where real-time community information is made available to the member. An example of real-time community information that an organization may want to make available to all members is a message to all members regarding the deadline for an upcoming conference.

In one embodiment of Member Crossing, the part of the administrative interface designed to send e-marketing messages will be enhanced to allow the same message to be sent out to the browser toolbar of all members. The browser toolbar could poll for new messages and show a change in the UI of the toolbar when it arrived to alert the user that they had a new message available for viewing. In some cases, it may be preferable to send messages just to the toolbar since the toolbar supports interactivity normally not possible in HTML email messages such as forms which can be filled out and submitted.

This feature would allow administrators at the organization to enter HTML alert messages to be sent out to either individual members, all of the members in a particular group or to all members. The following forms of interactivity could also be available in the browser toolbar:
Subscription to RSS feeds
Ability to add new blog entry
Ability to create a Trackback URL for a grouponomy node
Ability to add a bookmark to an URL and associate the bookmark to a grouponomy node as well as assign a list of tags (synonyms) to the URL.

The toolbar may also support live lookups for the active URL to see if it has already been added to Member Crossing. If it has, then the toolbar could show through a label that it has been added with the option to click the label to see more detailed information about where this resource appears in Member Crossing. The lookups to see if the resource has already been added could be performed asynchronously as the page is loading. In another embodiment of this solution, the toolbar could load a div or an iframe into the page when it has been determined that the page has already been added to Member Crossing. This div tag or iframe could present a list of the locations where this page has been added to Member Crossing along with links to each of these nodes for quick access to the information in Member Crossing that may be related to this page. If an HTML element such as a div or an iFrame is shown in the page, it is possible to show this element initially to the far right as a small bar, possibly of just a solid color, which, when clicked, would cause the HTML element to either slide into view or appear in full site within the page. An editable option may be available to the user to determine where this bar would appear in the page (top, bottom, left, right, etc.). This visual element may or may not be shown in the page when the page loads. It may be necessary for the member to click a region of the toolbar or select an interface element in the toolbar in such a way as to denote that they would like to see the grouponomy pages to which this resource has already been associated.

In addition to the browser toolbar, Member Crossing staff may spend time creating custom add-ons and scripts for a variety of platforms including, but not limited to:
Greasemonkey scripts
Productivity tools add-ins such as for any of the Office tools
Blogging tool add-ins

The purpose of these tools may vary, but they will center around integrating the services and features of Member Crossing with the tools members will be using on a daily basis in order to make it as easy as possible and as seamless as possible to add knowledge in the appropriate locations inside of Member Crossing.

As mentioned above, the toolbar may provide quick access to nodes which have been bookmarked by the logged in member. The toolbar may additionally support viewing a distinct list of the recently used nodes for the purpose of easily associating the current resource with one of the nodes in the list.

Integration with Other Social Networking Tools

Varying levels of integration will be targeted for the use of and inclusion of social networking tools such as del.icio.us, LinkedIn, Facebook and others. Member Crossing may employ the use of a CSS and JavaScript feature which uses the state of the visited link for known social networking sites to be detected on the client and sent back to the server. This would be used only to present a list of the social networking sites which Member Crossing currently supports from an integration perspective.

Integration would be developed at different levels depending on the API made available by the social networking sites being integrated. For example, with del.icio.us, an open API is available which would allow members to import their del.icio.us bookmarks into the Member Crossing system. Additionally, it may be possible using this API to allow members to simultaneously add bookmarks to multiple systems. This would ensure that member's investment in third party social networking tools would be preserved.

In one embodiment, this integration is provided through both the browser toolbar as well as the online tools available for adding resources such as bookmarks to the system. The sub-system providing the integration may be a system designed to use web services and some type of asynchronous messaging such as is available in MSMQ or in Microsoft SQL Server Service Broker. These messages would be processed by a service which could initiate a set of processes that would handle the integration required by the member. This set of processes could be configured using a pattern such as a pipeline pattern which would allow multiple types of integration to be handled based on the member's integration settings.

In order to provide integration with third party social networking sites and services, members will need an interface and the underlying infrastructure to store their authentication information for sites and services that require authentication. For security purposes, this information should be encrypted.

Modified MVP Pattern for Modules

The modules may be developed using a modified version of the MVP design pattern for designing applications that keep a separation between the user experience (UX) and the underlying code.

Staff at IT Crossing have developed a set of base class libraries which automate a great deal of the work normally done to use the MVP pattern. Normally, when the MVP pattern is used, an interface is defined for the view and any of the controls on the view that either show or update data require a corresponding property to be created on the view.

There are two main base classes designed by IT Crossing: a base class for the view and a base presenter class.

The base class for the view is written for a specific user interface technology. For example, the prototype is written for web applications. This base class reads through all of the controls inside of the view, which derive from the base class, and identifies the controls in the page which fall into 3 categories:
Read only controls
Edit controls used for updates or inserts
User interface elements which can be programmatically determined to be either an insert, update or delete control

The code in this base class wires up the events for any update controls in the page and is responsible for communicating with the base presenter class regarding any controls that should be populated with data. Coordination is made between the base presenter class and the base view class through predefined interfaces that allow the presenter to set the properties of the read only and edit controls found in the page based on the data retrieved from the model.

The model is accessed through another predefined interfaCe which allows the presenter to deal with different model objects without regard to the implementation of the model. The adapter pattern is used here to allow interaction with objects from external ORM generated classes to function as the model.

As much as is possible, the business logic will be centralized at one layer below any web services layer that is added on top of the domain logic. This will ensure that business rules are defined in only one location and are accessible to both the web services APIs as well as the custom code available through other user interfaces.

Additionally, validation logic should be managed at a layer low enough to allow for one definition of validation that flows through all levels of access to the data services layer.

Future UX Models

One of the goals of using the modified MVP approach to designing the Member Crossing data services infrastructure will be to ensure that future user experiences developed for accessing Member Crossing data from other devices will be able to make use of the existing code base. Examples of some of the target user experiences for future releases of Member Crossing include, but are not limited to:
Mobile
WPF
Silverlight
Widgets

Method of Determining Member Affinity (Birds of a Feather)

A method of determining member affinity may be added to the system which may employ a process whereby members choose one or more grouponomy nodes from the grouponomy and view a list of the members who are related to either all of these nodes or some percentage of these nodes. How the member is related could be configurable. For example, a member may want to see everyone who is listed as someone to contact regarding these nodes. They may also want to see every other member who has blogged about the nodes selected and in one embodiment of the solution may also be able to see other members who have viewed the information. In another embodiment of the solution, the information regarding who has viewed content in a node may not be immediately visible to the member, but may be used in the calculations regarding member affinity.

An interface could be created which would allow the member to choose one or more types of relationship to a node, such as has added content, or has blogged about, or is listed as contact, choose one or more nodes, and choose what percentage of those nodes the members must be related to according to the rules selected. This interface could additionally include a way to select whether or not child nodes of the selected nodes should be included.

This same concept may be used to allow members to find other members within the system. For example, if a member wanted to see a list of members who were related in some way to a grouponomy node and possible all of its children, the member would use an interface similar to the one described to select the type of relationship to the node and view the members.

A similar method could be employed using the synonyms associated with the grouponomy nodes. Members could pick a synonym and view all of the members associated at different levels (node related contacts, contributors to the node, etc) to all of the nodes associated with that synonym.

I claim:

1. A computer-implemented method of a knowledge management system shared by a plurality of users for the purpose of creating meaningful connections between the users and sharing one or more knowledge resources, wherein each knowledge resource is associated with one or more shared taxonomies recognized by the plurality of users as the authority for an aspect of knowledge shared by members of a group formed by the plurality of users, comprising:
a) receiving a request by at least one of the plurality of users to create one ore more shared taxonomies, the shared taxonomies each having one or more nodes, each node having zero or more classes associated with the node for the purpose of associating metadata with the nodes and each node having a content region which may contain HTML or text content along with zero or more modules associated with the node for the purpose of associating knowledge resources specific to each module with the node where knowledge resources associated with each module are referred to for the purposes of describing the knowledge resources as items, and wherein such items each represent a knowledge object and these items are associated with the module as well as with the node either directly or indirectly by virtue of being associated with a module which is associated with the node;
b) receiving one or more requests by one or more of the users to modify the structure of one or more of the shared taxonomies, the request being allowed or disallowed based on rules defined by the knowledge management system;
c) receiving a request by one or more of the plurality of users to associate one or more knowledge resources with one or more nodes in the taxonomy, each knowledge resource being maintained as an item associated with a module;
d) receiving a request by one or more of the plurality of users to retrieve data from one or more knowledge resources associated with one or more modules related to a specific node in the taxonomy; and
e) receiving a request to have a knowledge resource added to the system, the request being mapped to a node in the system even when that node may have been renamed or moved within the system, this mapping being enabled by an identifier related to each node in the system which is designed to be immutable for the life of the node in the system.

2. The method of claim 1 further comprising a request to view an aggregate version of knowledge resources related to one or more modules which are associated with one or more of the children of a specific node.

3. The method of claim 1 further comprising a request to limit the presentation of knowledge resources within the knowledge management system based on a filter of the knowledge resources maintained in the system which is defined by a user using an interface connected to a computing device to select one or more modules to be used as the basis for the filter.

4. The method of claim 1 wherein requests which are received by the knowledge management system to alter the structure of one or more of the shared taxonomies are restricted to two types of nodes which are defined as either things or categories of things, with a default assignment of categories of things to any nodes which are created in the system without specifying the default type of node to be used and with each such category containing zero or more sub-types.

5. The method of claim 1 further comprising a request by one or more of the plurality of users to assign 1 or more classes with a node, each class comprising data and possibly behavior in the form of template which contain predefined data related to the fields which are tracked for the particular class, the data being saved in a format which allows the data related to a subset of related classes to be shown to the user in aggregate form, the aggregation being determined based on at least one of the following: nodes with the same name, linked nodes, nodes sharing the same parent in the hierarchy of the taxonomy and nodes which are related through a related nodes collection maintained by the knowledge management system.

6. The method of claim 1 further comprising a request handled by the system for all data related to one or more of the modules available in the knowledge management system, the interfaces of the system being designed to return information which highlights the location in the shared taxonomy where items related to the selected modules have been associated with taxonomy nodes, a representation depicting all the nodes in the taxonomy and using formatting or images to convey said locations within the taxonomy, the formatting being used to denote one or more of the following: nodes which only contain child nodes which contain items related to the selected modules and nodes which immediately contain items related to the selected modules

7. The method of claim 1 further comprising a request to associate a new node in the taxonomy where the new node already exists in the knowledge management system, where the process of linking the existing node under a separate parent node in the taxonomy allows the system to return information which may be conveyed based on the existence of the node in more than one place in the taxonomy.

8. The method of claim 1 further comprising a request sent to the knowledge management system where pingback and trackback technologies are used to make it easy for members to associate knowledge resources such as blog posts with content in the shared taxonomy using existing blogging tools.

9. The method of claim 1 further comprising a request for a node in the system using a code which uniquely identifies the node, where the code is short enough in length to be easily remembered by the plurality of users of the system and where the code can be added to the end of a known domain and path and combined with a web addressable protocol to create a short URL which uniquely identifies the location of web-enabled resources related to the node such as: a web page showing content related to the node or a web services API designed to return information about the node.

10. The method of claim 1 further comprising a request made to add a new node to the shared taxonomy where the request is entered as text using a common syntax used for creating new pages in a wiki, the syntax being extended to allow the following information to be conveyed in the textual request to create the node: position of the new node relative to the node where the text is being entered in the main content region related to the node.

11. The method of claim 1 further comprising a request to retrieve a list of users associated with a particular aspect of knowledge as associated with one or more shared taxonomy nodes, that request being processed and the resulting data being returned based on data associated with the one or more nodes including but not limited to: authors related to the node, users who have contributed module items related to the node or any of the child nodes, users who have left comment related to the nodes and users who have associate themselves with the nodes using a module such as a related users module

12. A computing device containing instructions which can be executed on one or more processors which is designed to produce a community knowledge system designed to provide context for community knowledge of various types comprising;
a) A shared, hierarchical mechanism for categorizing information called a grouponomy, wherein each node in the hierarchy represents some aspect of knowledge to be tracked by the system which is uniquely identifiable and attached to resources of a variety of types;
b) A mechanism for associating resources to a node in the hierarchy whereby said mechanism for associating resources is initiated by the act of referencing an URL or unique identifier designed specifically for said node and whereby the result of said mechanism for associating resources is an association of said node to said resource which provides context to said resource for members of the community who are able to access said community knowledge system;
c) A mechanism which associates zero or 1 content regions with each node added to the grouponomy;
d) A mechanism which allows zero or more modules to be associated with each node in the grouponomy, where each module contains items which represent discrete knowledge resource objects including but not limited to: documents, images, videos, links, surveys, discussion threads, related users, thesaurus terms and other possible examples of modules listed in the detailed description of the invention;
e) A mechanism which allows members, possibly a select group, of the community around which the grouponomy nodes are shared to contribute to the content and structure of the grouponomy by managing the nodes and the types assigned to each node whether it is a category or a thing or a subtype of one of these two;
f) A set of 1 or more tools designed to allow members of the community to assign knowledge resources to one or more nodes in said hierarchical table of contents;
g) A mechanism for members of said community knowledge system to view aggregated information from modules which are related to nodes, thereby allowing members to have access to aggregated information for all nodes in the grouponomy which contain children and which contain modules which support aggregation;
h) A system for maintaining the identity of a node in the grouponomy forever and for the identity of that node to remain, even being merged with other nodes, or being split into two separate nodes;
i) A mechanism for members, possibly a select group of said community, to manage 0 or more grouponomies;
j) A mechanism for members of said community to manage 0 or more classes of nodes in the hierarchy where classes provide a way of keeping track of a specific type of data defined by one or more fields for entering and storing data;
k) A mechanism for members of said community to manage 0 or more classes related to a particular node in the system in such as way as to associate data that can be stored with a class to a particular node; and
l) A mechanism for members of said community to manage, with appropriate levels of access the nodes that appear in the grouponomy or grouponomies managed by the system.

13. The community knowledge system of claim 12 wherein new nodes are added to a shared taxonomy through a request which is entered as text in the main content region of the node using a common syntax used for creating new pages in a wiki, the syntax being extended to allow the following information to be conveyed in the textual request to create the node: position of the new node relative to the node where the text is being entered in the main content region related to the node.

14. The community knowledge system of claim 12 wherein a request can be made for a node in the system using a code which uniquely identifies the node, where the code is short enough in length to be easily remembered by the plurality of users of the system and where the code can be added to the end of a known domain and path and combined with a web addressable protocol to create a short URL which uniquely identifies the location of web-enabled resources related to the node such as: a web page showing content related to the node or a web services API designed to return information about the node.

15. The community knowledge system of claim 12 wherein a request can be sent to the knowledge management system where pingback and trackback technologies are used to make it easy for members to associate knowledge resources such as blog posts with content in the shared taxonomy using existing blogging tools.

16. The community knowledge system of claim 12 wherein a request can be processed to retrieve a list of users associated with a particular aspect of knowledge as associated with one or more shared taxonomy nodes, that request being processed and the resulting data being returned based on data associated with the nodes including but not limited to: authors related to the node, users who have contributed module items related to the node or any of the child nodes, users who have left comments related to the nodes and users who have associated themselves with the node using a module such as a related users module.

17. The community knowledge system of claim 12 wherein content can be discovered by the system inside external systems and resources based on the existence of one or more URLs which have been created either using a rel attribute of an anchor tag or through the existence of QueryStrings in such one or more URLs which provide the information necessary for the community knowledge system to determine that the resource should be associated with one or more nodes in the grouponomy if the association is not already made.

18. The community knowledge system of claim 12 wherein a view is available for each module available in the community knowledge system that view making it possible for users of the system to quickly identify all of the nodes in the system where all of the knowledge resources tracked by that module are associated.

19. The community knowledge system of claim 12 wherein groups may have a profile page which shows aggregate information regarding community involvement by group members as well as community related information from the system related to the group.
